(19) United States
(12) Patent Application Publication
(10) Pub. No.: US 2020/0399433 A1
(43) Pub. Date: Dec. 24, 2020

(54) IMPROVEMENT OF IMPACT PROPERTIES OF DYNAMICALLY CROSS-LINKED NETWORKS BY USING REACTIVE IMPACT MODIFIERS

(71) Applicant: SABIC GLOBAL TECHNOLOGIES B.V., Bergen op Zoom (NL)

(72) Inventors: Ramon GROOTE, Oisterwijk (NL); Johannes Gerardus Petrus GOOSSENS, Heeswijk-Dinther (NL)

(21) Appl. No.: 16/464,464

(22) PCT Filed: Nov. 29, 2017
(86) PCT No.: PCT/IB2017/057510

§ 371 Date: May 28, 2019

Related U.S. Application Data
(60) Provisional application No. 62/428,424, filed on Nov. 30, 2016.

(51) Int. Cl. C08J 3/24; C08G 63/85; C08G 63/91; C08L 63/00

(52) U.S. Cl. CPC C08J 3/24; C08G 63/85; C08J 2367/02; C08L 63/00; C08J 2463/02; C08G 63/916

(57) ABSTRACT

Provided are pre-dynamically cross-linked compositions including a networking impact modifier additive. Compositions include a pre-dynamic cross-linked polymer composition including polyester chains joined by a coupler component and one or more networking impact modifier additives. Methods of making the compositions are also described.

### FIELD

The present disclosure relates to dynamic cross-linked polymer compositions, and in particular to compositions including polyester chains joined by a coupler component and one or more networking impact modifier additives.

### BACKGROUND

“Dynamic cross-linked polymer compositions” (or DCNs) represent a versatile class of polymers. The compositions feature a system of covalently cross-linked polymer networks and can be characterized by the nature of their structure. At elevated temperatures, the cross-links undergo transesterification reactions at such a rate that a flow-like behavior can be observed. Here, the polymer can be processed much like a viscoelastic thermoplastic. At lower temperatures, these dynamic cross-linked polymer compositions behave more like classical thermosets. As the rate of inter-chain transesterification slows down, the network becomes more rigid. The dynamic nature of their cross-links allows these polymers to be heated, reheated, and reformed, as the polymers maintain structural integrity under demanding conditions. Existing DCN composition systems typically include semi-crystalline base resins, such as polybutylene. Semi-crystalline materials however are intrinsically brittle and exhibit poor resistance to failure against impact. While the dynamic cross-linking behavior results in improved stiffness of these materials, impact performance does not necessarily improve. Indeed, impact performance tends to deteriorate.

These and other shortcomings are addressed by aspects of the present disclosure.

### SUMMARY

Aspects of the present disclosure relate to compositions comprising: a pre-dynamic cross-linked polymer composition, wherein the pre-dynamic polymer composition comprises a polyester component chains joined by a coupler component and a networking impact modifier additive.

The present disclosure provides methods of reacting (a) a coupler component comprising at least two epoxy groups and (b) a chain component comprising a polyester having one or more reactive end groups; and adding one or more networking impact modifier additives comprising one or more groups reactive with the one or more reactive end groups of the chain component, under such conditions that the one or more networking impact modifier additives covalently bond to the one or more reactive end groups of the chain component, the reaction being performed in the presence of at least one catalyst that promotes the formation of the pre-dynamic cross-linked composition, and the pre-dynamic cross-linked composition when subjected to a curing process (a) exhibits a plateau modulus of from about 0.01 megapascals (MPa) to about 1000 MPa when measured by dynamic mechanical analysis at a temperature above a melting temperature of the polyester of the pre-dynamic cross-linked composition and (b) exhibits a capability of relaxing internal residual stresses at a characteristic timescale of between 0.1 and 100,000 seconds above a glass transition temperature of the polyester, as measured by stress relaxation rheology measurement.

The present disclosure further provides methods of forming an article that comprises a pre-dynamic cross-linked polymer composition, comprising: preparing a pre-dynamic cross-linked polymer composition according to the methods of the present disclosure; and subjecting the pre-dynamic cross-linked polymer composition to one or more of a compression molding process, a profile extrusion process, or a blow molding process so as to form the article.

The present disclosure also provides articles formed from the described polymer compositions. Further provided are methods of forming an article, comprising a dynamic cross-linked polymer composition comprising preparing a dynamic cross-linked polymer composition and subjecting the dynamic cross-linked polymer composition to a conventional polymer forming process, such as compression molding, profile extrusion, injection molding, or blow molding to form the article.

The above described and other features are exemplified by the following drawings, detailed description, examples, and claims.

### BRIEF DESCRIPTION OF THE DRAWINGS

The following is a brief description of the drawings wherein like elements are numbered alike and which are exemplary of the various aspects described herein.

FIG. 1 depicts the storage (solid line) and loss (dashed line) modulus of the oscillatory time sweep measurement curves for a cross-linked polymer network.

FIG. 2 depicts the normalized modulus (G/G₀) for the dynamically cross-linked polymer network (solid line), as well as a line representing the absence of stress relaxation in a conventionally cross-linked polymer network (dashed line, fictive data).

FIG. 3 depicts storage modulus as a function of temperature according to a dynamic mechanical analysis (DMA) for several exemplary compositions.

FIG. 4 depicts the dynamic mechanical analysis for inventive samples E2a and E2c having 5 wt. % (solid line) and 15 wt. % (dotted line) GMA poly(ethylene-acrylate) copolymer respectively.

FIG. 5 depicts the stress relaxation rheology curves for inventive samples E2a and E2c having 5 wt. % (solid line) and 15 wt. % (dotted line) GMA poly(ethylene-acrylate) copolymer respectively.

FIG. 6 depicts the tensile modulus for inventive samples E2a through E2c (Lotader® AX8900) and E3a through E3c (Lotader® 3430).

FIG. 7 depicts the elongation strain at break for inventive samples E2a through E2c (Lotader® AX8900) and E3a through E3c (Lotader® 3430).

FIG. 8 depicts the Izod notched impact strength for inventive samples E2a through E2c (Lotader® AX8900) and E3a through E3c (Lotader® 3430).

FIG. 9 depicts the Izod notched impact strength for inventive samples E2a through E2c (Lotader® AX8900) and E3a through E3c (Lotader® 3430) at varying temperatures from −50° C. to 30° C.

FIGS. 10-13 are data tables referred to in the Examples as Tables 1-4, respectively.

### DETAILED DESCRIPTION OF ILLUSTRATIVE ASPECTS

The present disclosure may be understood more readily by reference to the following detailed description of desired aspects and the examples included therein. In the following specification and the claims that follow, reference will be made to a number of terms that have the following meanings.

Described herein, inter alia, are methods of making compositions, i.e., dynamic cross-linked polymer compositions. These compositions are advantageous because they can be prepared more readily than dynamic cross-linked or cross-linkable polymer compositions previously described in the art.

### Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the aspects “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Numerical values in the specification and claims of this application, particularly as they relate to polymers or polymer compositions, oligomers or oligomer compositions, reflect average values for a composition that may contain individual polymers or oligomers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

As used herein, “Tm” refers to the melting point at which a polymer, or oligomer, completely loses its orderly arrangement. As used herein, “Tc” refers to the polymer's crystallization temperature. The terms “Glass Transition Temperature” or “Tg” refer to the maximum temperature at which a polymer will still have one or more useful properties. These properties include impact resistance, stiffness, strength, and shape retention. The Tg therefore may be an indicator of its useful upper temperature limit, particularly in plastics applications. The Tg may be measured using a differential scanning calorimetry method and expressed in degrees Celsius (° C.).

As used herein, “cross-link,” and its variants, refer to the formation of a stable covalent bond between two polymer chains. This term is intended to encompass the formation of covalent bonds that result in network formation. The term “cross-linkable” refers to the ability of a polymer to form such stable covalent bonds.

As used herein, “pre-dynamic cross-linked polymer composition” refers to a mixture comprising all the required elements to form a dynamic cross-linked polymer composition, but which has not been cured sufficiently to establish the requisite level of cross-linking for forming a dynamic cross-linked polymer composition. Upon sufficient curing, for example, heating to temperatures up to about 320° C., a pre-dynamic cross-linked polymer composition may convert to a dynamic cross-linked polymer composition. In some aspects, curing may comprise heating the composition to a temperature above the glass transition temperature of the polyester component, when applicable. Curing may also be effected, when applicable, at a temperature between the glass transition temperature and melting temperature of the polyester component. As an example, sufficient curing may occur, for example, by heating the composition to a temperature between 150° C. and 270° C. to convert the pre-dynamic cross-linked polymer composition to a dynamic cross-linked polymer composition. Pre-dynamic cross-linked polymer compositions may comprise a coupler component and a chain (in some aspects, the chain comprising a polyester) component. A coupler component may comprise at least two reactive groups, e.g., two, three, four, or even more reactive groups. Suitable reactive groups include, e.g., epoxy/epoxide groups, anhydride groups, glycerol and/or glycerol derivative groups, and the like. A coupler component may act to crosslink polymer chains, e.g., to crosslink polyester chains. A coupler component may also act as a chain extender. In certain aspects, at least some residual reactive groups (e.g., unreacted epoxy groups) of the coupler component remain in the pre-dynamic cross-linked polymer composition. In further aspects, all reactive groups may be consumed in the formation of the pre-dynamic cross-linked polymer composition.

A pre-dynamic cross-linked composition may in some aspects comprise a polymer component comprising a pre-dynamic cross-linked polymer composition, wherein the pre-dynamic polymer composition comprises polyester component chains linked by a coupler component and further comprises one or more networking impact modifier additives. The pre-dynamic cross-linked composition may be formed in the presence of a suitable catalyst. The pre-dynamic crosslinked may also comprise optional additives. In a specific example, the pre-dynamic cross-linked polymer compositions described herein may comprise a coupler component and a polyester component reacted in the presence of one or more catalysts. The pre-dynamic composition may also comprise one or more additional additives, e.g., fillers such as glass fiber (or other fibers) or talc.

As used herein, “dynamic cross-linked polymer composition” refers to a class of polymer systems that include dynamically, covalently cross-linked polymer networks. At low temperatures, dynamic cross-linked polymer compositions behave like classical thermosets, but at higher temperatures, for example, temperatures up to about 320° C., it is theorized that the cross-links have dynamic mobility, resulting in a flow-like behavior that enables the composition to be processed and re-processed. Dynamic cross-linked polymer compositions incorporate covalently cross-linked networks that are able to change their topology through thermos-activated bond exchange reactions. The network is capable of reorganizing itself without altering the number of cross-links between its chains of chain segments. At high temperatures, dynamic cross-linked polymer compositions achieve transesterification rates that permit mobility between cross-links, so that the network behaves like a flexible rubber. At low temperatures, exchange reactions are very slow and dynamic cross-linked polymer compositions behave like classical thermosets. Put another way, dynamic cross-linked polymer compositions can be heated to temperatures such that they become liquid without suffering destruction or degradation of their structure. The viscosity of these materials varies slowly over a broad temperature range, with behavior that approaches the Arrhenius law. Because of the presence of the cross-links, a dynamic cross-linked polymer composition will not lose integrity above the Tg or Tm like a thermoplastic resin will. The cross-links are capable of rearranging themselves via bond exchange reactions between multiple cross-links and/or chain segments as described, for example, by Kloxin and Bowman, Chem. Soc. Rev. 2013, 42, 7161-7173. The continuous rearrangement reactions may occur at room or elevated temperatures depending upon the dynamic covalent chemistry applicable to the system. The respective degree of cross-linking may depend on temperature and stoichiometry. Dynamic cross-linked polymer compositions of the disclosure can have Tg of about 40° C. to about 60° C. An article made from a dynamic cross-linked polymer composition can be heated and deformed, and upon returning to the original temperature, maintains the deformed shape. As such, articles in accordance with the present disclosure may comprise a shape generated by applying mechanical forces to a molded piece formed from the dynamic cross-linked polymer composition. This combination of properties permits the manufacture of shapes that are difficult or impossible to obtain by molding or for which making a mold would not be economical. Dynamic cross-linked polymer compositions generally have good mechanical strength at low temperatures, high chemical resistance, and low coefficient of thermal expansion, along with processability at high temperatures. Examples of dynamic cross-linked polymer compositions are described herein, as well as in U.S. Patent Application No. 2011/0319524, WO 2012/152859; WO 2014/086974; D. Montarnal et al., Science 334 (2011) 965-968; and J. P. Brutman et al, ACS Macro Lett. 2014, 3, 607-610. As an example, articles may be formed from the dynamic cross-linked polymer compositions of the present disclosure and may include composites, a thermoformed material, or a combination thereof.

Examining the nature of a given polymer composition can distinguish whether the composition is cross-linked, reversibly cross-linked, or non-crosslinked, and distinguish whether the composition is conventionally cross-linked or dynamically cross-linked. Dynamically cross-linked networks feature bond exchange reactions proceeding through an associative mechanism, while reversible cross-linked networks feature a dissociative mechanism. That is, the dynamically cross-linked composition remains cross-linked at all times, provided the chemical equilibrium allowing cross-linking is maintained. A reversibly cross-linked network however shows network dissociation upon heating, reversibly transforming to a low-viscous liquid and then reforming the cross-linked network upon cooling. Reversibly cross-linked compositions also tend to dissociate in solvents, particularly polar solvents, while dynamically cross-linked compositions tend to swell in solvents as do conventionally cross-linked compositions.

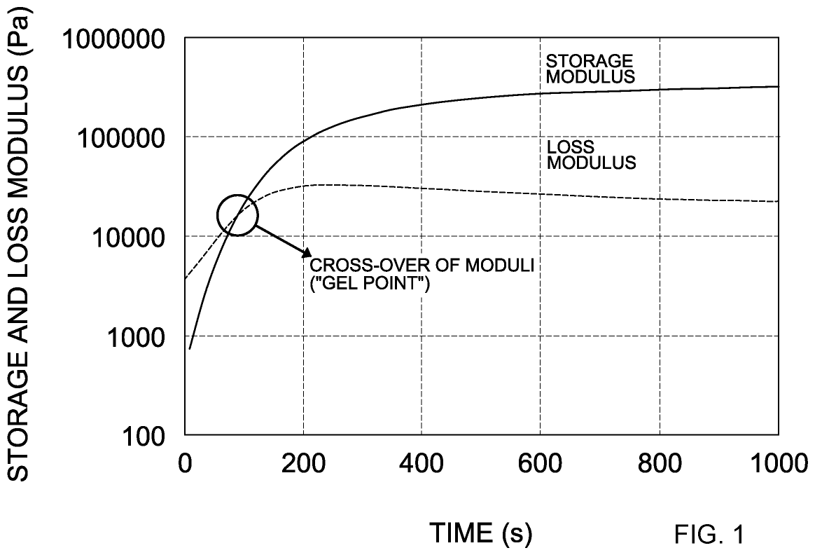

The cross-linked network apparent in dynamic and other conventionally cross-linked systems may also be identified by rheological testing. An oscillatory time sweep (OTS) measurement at fixed strain and temperature may be used to confirm network formation. Exemplary OTS curves are presented in FIG. 1 for a cross-linked polymer network.

A curve may indicate whether or not the polymer has a cross-linked network. Initially, the loss modulus (viscous component) has a greater value than the storage modulus (elastic component) indicating that the material behaves like a viscous liquid. Polymer network formation is evidenced by the intersection of the loss and storage modulus curves. The intersection, referred to as the “gel point,” represents when the elastic component predominates the viscous component and the polymer begins to behave like an elastic solid.

In distinguishing between dynamic cross-linking and conventional (or non-reversible) cross-linking, a stress relaxation measurement may also, or alternatively, be performed at constant strain and temperature.

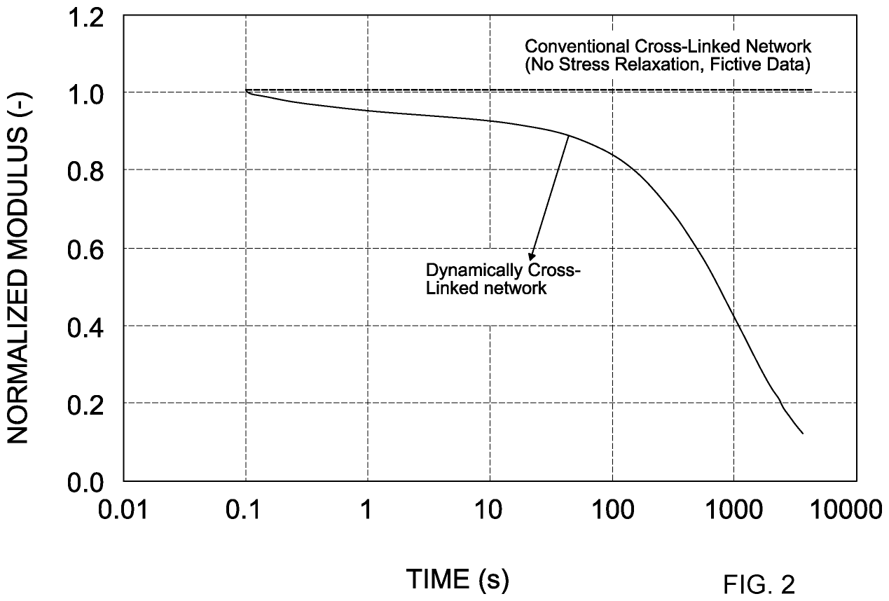

After network formation, the polymer may be heated and a certain strain is imposed on the polymer. After removing the strain, the resulting evolution of the elastic modulus as a function of time reveals whether the polymer is dynamically or conventionally cross-linked. Exemplary curves for dynamically and conventionally cross-linked polymer networks are presented in FIG. 2.

Stress relaxation generally follows a multimodal behavior:

$$G \text{/} {G}_{0} = {\sum }_{i = 1}^{n} {C}_{i} exp ( - t \text{/} {τ}_{i} ) ,$$

where the number (n), relative contribution (Cᵢ) and characteristic timescales (τᵢ) of the different relaxation modes are governed by bond exchange chemistry, network topology and network density. For a conventional cross-linked networks, relaxation times approach infinity, τ→∞, and G/G₀=1 (horizontal dashed line). Apparent in the curves for the normalized modulus (G/G₀) as a function of time, a conventionally cross-linked network does not exhibit any stress relaxation because the permanent character of the cross-links prevents the polymer chain segments from moving with respect to one another. A dynamically cross-linked network, however, features bond exchange reactions allowing for individual movement of polymer chain segments thereby allowing for complete stress relaxation over time.

If the networks are DCNs, they should be able to relax any residual stress that is imposed on the material as a result of network rearrangement at higher temperature. The relaxation of residual stresses with time (t) can be described with single-exponential decay function, having only one characteristic relaxation time τ*:

$$G ( t ) = G ( 0 ) \times exp ( - \frac{t}{{τ}^{*}} )$$

A characteristic relaxation time can be defined as the time needed to attain particular G(t)/G(0) at a given temperature. At lower temperature, the stress relaxes slower, while at elevated temperatures network rearrangement becomes more active and hence the stress relaxes faster, proving the dynamic nature of the network. The influence of temperature on the stress relaxation modulus clearly demonstrates the ability of the cross-linked network to relieve stress or flow as a function of temperature.

As shown in FIG. 2, the starting point for stress relaxation measurements, to may be selected to be 0.1 seconds, because the experimental set-up typically does not allow for reliable measurements at timescales shorter than 0.1 seconds. This may be attributed to inertial effects, “setting” of a sample between rheometer plates. Ideally, the normalized modulus follows a (multi-) exponential decay over time:

Normalized modulus=Σcᵢ×exp(−t/τᵢ*)≈exp(−t/τᵢ*), if τ₂*,τ₃*, . . . ,τₙ*>>τ₁*

Additionally, the influence of temperature on the stress relaxation rate in correspondence with transesterification rate were investigated by fitting the characteristic relaxation time, τ* to an Arrhenius type equation.

ln τ*=−Eₐ/RT+ln A

where Eₐ is the activation energy for the transesterification reaction.

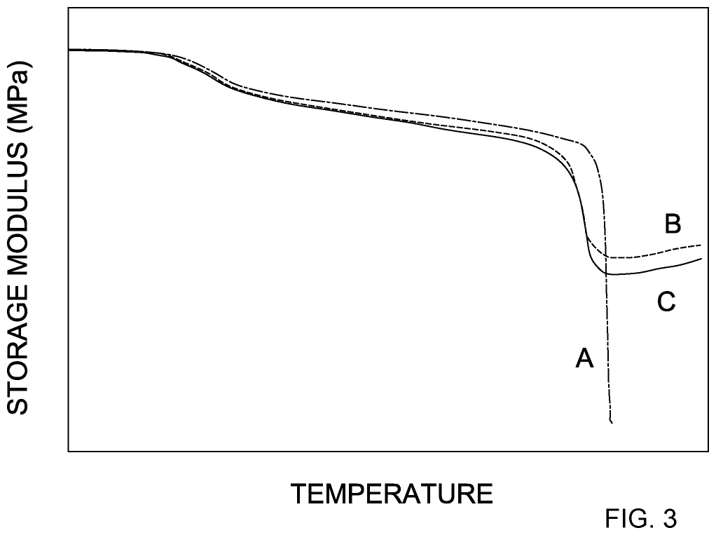

Generally, a dynamic mechanical analysis (DMA) of storage modulus as a function of temperature may exhibit particular characteristics. A dynamically cross-linked polymer composition may exhibit a plateau modulus of from about 0.01 megapascals (MPa) to about 1000 MPa, at a temperature above the melting temperature (and, depending on the polymer, above the glass transition temperature) of the polyester component. Non-limiting FIG. 3 provides a set of exemplary, qualitative curves. Two of the three curves (curves B and C) exhibit a plateau modulus above a certain temperature, thus depicting a dynamically cross-linked network. One of the three curves (curve A), instead of showing a plateau modulus above a certain temperature, exhibits an abrupt decline in modulus at the elevated temperature. Thus, curve A provides a qualitative depiction of a non-dynamically cross-linked polymer composition.

A pre-dynamic cross-linked composition, formed according to the present disclosure described herein, when subjected to a curing process may exhibit a plateau modulus of from about 0.01 MPa to about 1000 MPa, at a temperature above the melting temperature (and, depending on the polymer, above the glass transition temperature) of the polyester component as measured by dynamic mechanical analysis. The cured pre-dynamic cross-linked polymer composition may further exhibit the capability of relaxing internal residual stresses at a characteristic timescale of between 0.1 and 100,000 seconds above the glass transition temperature of the polyester component, as measured by a stress relaxation rheology measurement. It should be understood that in the case of some polymers, (including some semi-crystalline polymers, e.g., poly(butylene terephthalate) (PBT)) the cured pre-dynamic cross-linked polymer composition may further exhibit the capability of relaxing internal residual stresses at a characteristic timescale of between 0.1 and 100,000 seconds above the Tm for that polymer.

Described herein are pre-dynamic cross-linked polymer compositions and methods of making thereof. Further described are dynamic cross-linked polymer compositions formed from the pre-dynamic cross-linked polymer compositions.

Described herein are methods of preparing dynamic cross-linked polymer compositions including one or more networking additives. According to these methods, a coupler component (that includes a flame retardant species) and a polyester component are reacted in the presence of one or more catalysts. The resulting pre-dynamically cross-linked polymer composition may be subjected to a curing process to form a cured dynamically cross-linked polymer composition.

Described herein are methods of preparing dynamic cross-linked polymer compositions including one or more networking impact modifier additives. In one aspect, a coupler a chain component comprising a polyester, and a networking impact modifier may be reacted via a process such as a reactive extrusion. The reaction may be performed under such conditions so as to form a pre-dynamic cross-linked composition. The reaction may also be performed in the presence of at least one catalyst that promotes the formation of the pre-dynamic cross-linked composition. According to these methods, a coupler component, a polyester component, a networking impact modifier additive, and a catalyst may be reacted or combined at temperature of up to about 320° C. for about 15 minutes or fewer.

Semi-crystalline materials, such as PBT which may be used to form the polyester component of the DCN compositions described herein, may be intrinsically brittle and exhibit poor resistance against impact. While the dynamic cross-linking of the composition provides improved stiffness of these materials, impact performance may be further improved with the addition of an impact modifier additive. Some impact modifiers are introduced to the composition only after the post-curing step has been performed. For example, a non-reactive impact modifier, such as the thermally unstable impact modifier, methacrylate-butadiene-styrene (MBS), may undergo oxidative degradation when subjected to post-curing temperatures used in the formation of the DCN. It may be necessary to cure a pre-DCN composition and then re-compound the composition with a given rubber impact modifier additive to prevent deterioration of the impact modifier and effectively improve the impact resistance of a molded part formed from the composition.

In certain aspects, the reacting may occur for less than about 7 minutes so as to form the pre-dynamic cross-linked polymer composition. In other aspects, the reacting occurs for less than about 4 minutes. In yet other aspects, the reaction occurs for less than about 2.5 minutes. In still other aspects, the reacting occurs for between about 10 minutes and about 15 minutes.

In some aspects, the reacting occurs at temperatures of up to about 320° C. to form the pre-dynamic cross-linked polymer composition. In yet other aspects, the reacting may occur at temperatures between about 40° C. and about 320° C. In other aspects, the reacting occurs at temperatures between about 40° C. and about 290° C. In some aspects, the reacting occurs at temperatures between about 40° C. and about 280° C. In some aspects, the reacting occurs at temperatures of between about 40° C. and about 270° C. In still other aspects, the reacting occurs at temperatures of between about 70° C. and about 270° C. In other aspects, the combining step occurs at temperatures between about 70° C. and about 240° C. In still other aspects, the reacting occurs at temperatures between about 190° C. and about 270° C.

In some aspects of the present disclosure, the reaction occurs at a temperature that is less than the temperature of degradation of the chain or polyester component. That is, the reacting may occur at a temperature at which the polyester component is in a melted state. As one example, the reaction occurs at a temperature less than or about equal to the Tm of the respective polyester. In one example, where the polyester component is PBT, the reacting step may occur at about 240° C. to 260° C., below the degradation temperature of PBT.

The reacting step so as to form a pre-dynamic cross-linked polymer composition can be achieved using any means known in the art, for example, mixing, including screw mixing, blending, stirring, shaking, and the like. One approach for combining the coupler component, the polyester component, the non-networking additive, and the one or more catalysts is to use an extruder apparatus, for example, a single screw or twin screw extruding apparatus. In a specific example, the foregoing components may be compounded. The reaction may be performed in a reactor vessel (stirred or otherwise), and may also be performed as a reactive extrusion.

The methods described herein may be carried out under ambient atmospheric conditions, but it is preferred that the methods be carried out under an inert atmosphere, for example, a nitrogen atmosphere. In a certain aspect, the methods may be carried out under conditions that reduce the amount of moisture in the resulting pre-dynamic cross-linked polymer compositions described herein. For example, a pre-dynamic cross-linked polymer compositions described herein may have less than about 3.0 wt. %, less than about 2.5 wt. %, less than about 2.0 wt. %, less than about 1.5 wt. %, or less than about 1.0 wt. % of water (i.e., moisture), based on the weight of the pre-dynamic cross-linked polymer composition.

In some methods, the combination of the coupler component, the polyester component, the non-networking additive, and the one or more catalysts is carried out at atmospheric pressure. In other aspects, the combining step can be carried out at a pressure that is less than atmospheric pressure. For example, in some aspects, the combination of the coupler component, the polyester component, the one or more non-networking additive, and the catalyst is carried out in a vacuum.

The compositions of the present disclosure provide dynamically cross-linked compositions exhibiting the characteristic stress relaxation behavior associated with the formation of a dynamic network. In certain aspects of the present disclosure, to achieve a fully cured, dynamic cross-linked composition, pre-dynamic cross-linked polymer compositions prepared herein undergo a post-curing step. The post-curing step may include heating the obtained composition to elevated temperatures for a prolonged period. The composition may be heated to a temperature just below its melt or deformation temperature. Heating to just below the melt or deformation temperature of the polyester component may activate the dynamically cross-linked network, thereby, curing the composition to a dynamic cross-linked polymer composition.

A post-curing step may be applied to activate the dynamic cross-linked network in certain compositions of the present disclosure; formation of a dynamic cross-linked network when using certain coupler components may be facilitated with a post-curing step is performed to facilitate the formation of the dynamic cross-linked network. For example, a post-curing step may be used for a composition prepared with a less reactive coupler component. Less reactive coupler components may include epoxy chain extenders that generate secondary alcohols in the presence of a suitable catalyst.

In yet further aspects of the present disclosure, certain compositions exhibit dynamic cross-linked network formation after a shorter post-curing step. As an example, a pre-dynamic cross-linked polymer composition prepared with a bisphenol A diglycidyl ether (BADGE) and a cycloaliphatic epoxy (ERL) as the coupler component may require a post-curing step to establish a dynamically cross-linked network in the final product.

In yet further aspects, compositions assume a dynamically cross-linked network formation and need not undergo a post-curing step. That is, these compositions do not require additional heating to achieve the dynamically cross-linked network. In some aspects, compositions derived from more reactive chain extenders exhibit dynamically cross-linked network behavior without heating. More reactive chain extenders can include epoxy chain extenders that generate primary alcohols in the presence of a suitable catalyst.

As described herein, the pre-dynamic cross-linked polymer composition may be subjected to a curing process to provide a dynamic cross-linked polymer composition. The curing process may comprise heating the pre-dynamic cross-linked composition to a temperature between about 170° C. to about 250° C. The pre-dynamic cross-linked polymer composition may be heated for up to about 8 hours.

The pre-dynamic (or after curing, the dynamic) cross-linked polymer compositions can be formed into any shape known in the art. Such shapes can be convenient for transporting the dynamic cross-linked polymer compositions described herein. Alternatively, the shapes can be useful in the further processing of the pre-dynamic cross-linked polymer compositions described herein into dynamic cross-linked polymer compositions and articles comprising them. For example, the pre-dynamic cross-linked polymer compositions can be formed into pellets. In other aspects, the pre-dynamic cross-linked polymer compositions can be formed into flakes. In yet other aspects, the pre-dynamic cross-linked polymer compositions can be formed into powders. In some aspects, cured dynamic cross-linked pellets may be re-compounded with additional amounts of the polyester component comprising desired additives.

The pre-dynamic and dynamic cross-linked polymer compositions described herein can be used in conventional polymer forming processes such as injection molding, compression molding, profile extrusion, and blow molding. For example, the dynamic cross-linked polymer compositions prepared according to the described methods can be melted and then injected into a mold to form an injection-molded article. The injection-molded article can then be cured by heating to temperatures of up to about 270° C., followed by cooling to ambient temperature. As an example, articles may be formed from the dynamic cross-linked polymer compositions of the present disclosure and may include composites, a thermoformed material, or a combination thereof.

Alternatively, the pre-dynamic cross-linked polymer compositions described herein can be melted, subjected to compression molding processes, and then cured. In other aspects, the pre-dynamic cross-linked polymer compositions described herein can be melted, subjected to profile extrusion processes, and then cured. In some aspects, the dynamic cross-linked polymer compositions described herein can be melted, subjected to blow molding processes, and then cured. The individual components of the pre-dynamic cross-linked polymer compositions are described in more detail herein.

### Polyester Chain Component

Present in the compositions described herein are polymers that have ester linkages, i.e., polyesters. The polymer can be a polyester that includes ester linkages between monomers. The polymer can also be a copolyester, which is a copolymer comprising ester and other linkages and.

The polymer having ester linkages can be a polyalkylene terephthalate, for example, poly(butylene terephthalate), also known as PBT, which has the structure shown below:

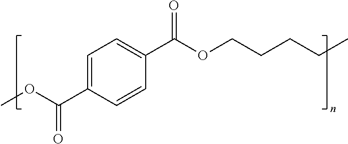

where n is the degree of polymerization, and can have a value as high as 1,000. The polymer may have a weight average molecular weight of up to 100,000 grams per mol (g/mol).

The polymer having ester linkages can be an oligomer containing ethylene terephthalate, described herein as an ET-oligomer, which has the structure shown below:

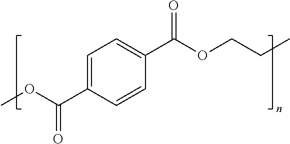

where n is the degree of polymerization, and can have a value up to 1000. The ethylene terephthalate oligomer may have an intrinsic viscosity between 0.09 dl/g and 0.35 dl/g

The polymer having ester linkages can be PCTG, which refers to poly(cyclohexylenedimethylene terephthalate), glycol-modified. This is a copolymer formed from 1,4-cyclohexanedimethanol (CHDM), ethylene glycol, and terephthalic acid. The two diols react with the diacid to form a copolyester. The resulting copolyester has the structure shown below:

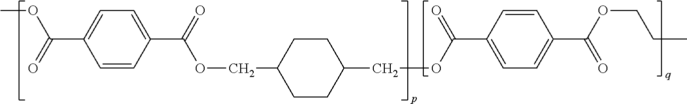

where p is the molar percentage of repeating units derived from CHDM, q is the molar percentage of repeating units derived from ethylene glycol, and p>q, and the polymer may have a weight average molecular weight of up to 100,000.

The polyester having ester linkages can also be ETG polyester. ETG-oligomer has the same structure as CTG-oligomer, except that the ethylene glycol is 50 mole % or more of the diol content. ETG polyester is an abbreviation for a polyester containing ethylene terephthalate, glycol-modified. In some aspects, the polymer having ester linkages can be poly(1,4-cyclohexane-dimethanol-1,4-cyclohexanedicarboxylate), i.e. PCCD, which is a polyester formed from the reaction of CHDM with dimethyl cyclohexane-1,4-dicarboxylate. PCCD has the structure shown below:

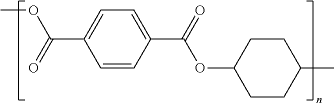

where n is the degree of polymerization, and can be as high as 1,000, and the polymer may have a weight average molecular weight of up to 100,000 g/mol.

The polymer having ester linkages can be poly(ethylene naphthalate), also known as PEN, which has the structure shown below:

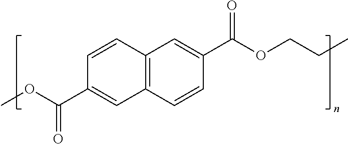

where n is the degree of polymerization, and can be as high as 1,000, and the polymer may have a weight average molecular weight of up to 100,000 g/mol.

The polymer having ester linkages can also be a copolyestercarbonate. A copolyestercarbonate contains two sets of repeating units, one having carbonate linkages and the other having ester linkages. This is illustrated in the structure below:

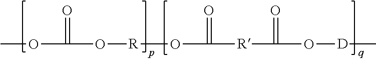

where p is the molar percentage of repeating units having carbonate linkages, q is the molar percentage of repeating units having ester linkages, and p+q=100%; and R, R′, and D are independently divalent radicals.

The divalent radicals R, R′ and D can be made from any combination of aliphatic or aromatic radicals, and can also contain other heteroatoms, such as for example oxygen, sulfur, or halogen. R and D are generally derived from dihydroxy compounds, such as the bisphenols of Formula (A). In particular aspects, R is derived from bisphenol-A. R′ is generally derived from a dicarboxylic acid. Exemplary dicarboxylic acids include isophthalic acid, terephthalic acid. 1,2-di(p-carboxyphenyl)ethane, 4,4′-dicarboxydiphenyl ether, 4,4′-bisbenzoic acid, 1,4-, 1,5-, or 2,6-naphthalenedicarboxylic acids, and cyclohexane dicarboxylic acid. As additional examples, the repeating unit having ester linkages could be butylene terephthalate, ethylene terephthalate, PCCD, or ethylene naphthalate as depicted above.

Aliphatic polyesters can also be used. Examples of aliphatic polyesters include polyesters having repeating units of the following formula:

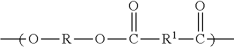

where at least one R or R¹ is an alkyl-containing radical. They are prepared from the polycondensation of glycol and aliphatic dicarboxylic acids.

By using an equimolar ratio between the hydroxyl/epoxy groups of the epoxy-containing component and the ester groups of the polymer having ester linkages, a moderately cross-linked polyhydroxy ester network can be obtained. The following conditions are generally sufficient to obtain a three-dimensional network:

N_{A}<N_{O}+2N_{X}

N_{A}>N_{X}

wherein N_{O} denotes the number of moles of hydroxyl groups; N_{X} denotes the number of moles of epoxy groups; and N_{A} denotes the number of moles of ester groups.

With the coupler component comprising at least two epoxy groups, the mole ratio of hydroxyl/epoxy groups (from the coupler epoxy-containing component) to the ester groups (from the polymer having ester linkages or the polyester component) in the system is generally from about 1:100 to about 5 to 100.

The pre-dynamic cross-linked polymer compositions of the present disclosure include a polyester component, e.g., an ester oligomer or polybutylene terephthalate (PBT). The polyester component may be present at, e.g., from about 10 wt. % to about 95 wt. % measured against the total weight of the pre-dynamic cross-linked composition.

### Coupler Component

The compositions of the present disclosure suitably include a coupler component. In various aspects, the coupler component may function as chain extender or a cross-linking agent. The coupler component of the present disclosure may comprise at two epoxy groups, which groups may be reacted or unreacted. In an aspect, the coupler component can be functional, that is, the component may exhibit reactivity with one or more groups of a given chemical structure. As an example, the coupler component described herein may be characterized by one of two reactivities with groups present within the ester oligomer component, i.e., a polyester-comprising chain component. The coupler component may react with 1) a carboxylic acid end group moiety of the chain component or 2) an alcohol end group moiety of the chain component. As described elsewhere herein, a coupler component suitably includes at least two reactive groups; exemplary such reactive groups include epoxy, anhydride, and glycerol/glycerol derivatives. Although many of the non-limiting examples provided herein present epoxy-including coupler components, it should be understood that these examples do not limit the scope of coupler components to coupler components that include only epoxy groups.

A coupler component may be a monomer, an oligomer, or a polymer. In an aspect, the coupler component may be multi-functional, that is having at least two epoxy groups. Generally, the epoxy-containing component has at least two epoxy groups, and can also include other functional groups as desired, for example, hydroxyl (—OH). Glycidyl epoxy resins are a particularly preferred epoxy-containing component. In further aspects, the epoxy-containing component may have three, four, five, or more epoxy groups.

One exemplary glycidyl epoxy ether is bisphenol A diglycidyl ether (BADGE), which can be considered a monomer, oligomer or a polymer, and is shown below as Formula (A):

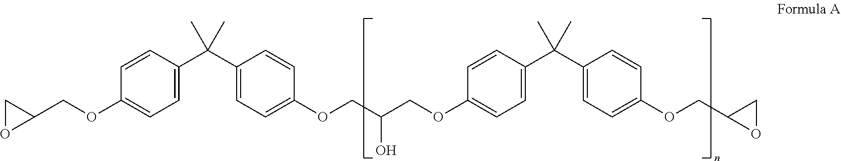

The value of n may be from 0 to 25 in Formula (A). When n=0, this is a monomer. When n=1 to 7, this is an oligomer. When n=8 to 25, this is a polymer. BADGE-based resins have excellent electrical properties, low shrinkage, good adhesion to numerous metals, good moisture resistance, good heat resistance and good resistance to mechanical impacts. BADGE oligomers (where n=1 or 2) are commercially available as D.E.R™ 671 from Dow. Novolac resins can be used as coupler component as well. Epoxy resins are illustrated as Formula (B):

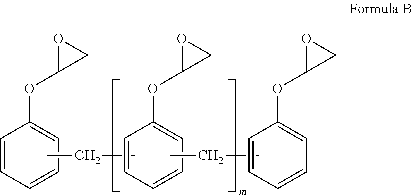

wherein m is a value from 0 to 25.

Another useful coupler component comprising at least two epoxy groups is depicted in Formula C, a cycloaliphatic epoxy (ERL).

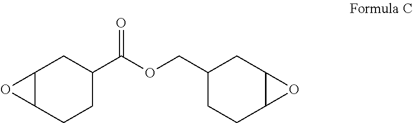 [SMILES: O=C(OCC1CCC2OC2C1)C1CCC2OC2C1]

For a monomeric bisphenol A epoxy, the value of n is 0 in Formula (A). When n=0, this is a monomer. BADGE-based resins have excellent electrical properties, low shrinkage, good adhesion to numerous metals, good moisture resistance, good heat resistance and good resistance to mechanical impacts. In some aspects of the present disclosure, the BADGE has a molecular weight of about 1000 Daltons and an epoxy equivalent of about 530 g per equivalent. As used herein, the epoxy equivalent is an expression of the epoxide content of a given compound. The epoxy equivalent is the number of epoxide equivalents in 1 g of resin (eq./g).

Exemplary coupler components of the present disclosure include monomeric epoxy compounds which generate a primary alcohol. In the presence of a suitable catalyst, the generated primary alcohol can readily undergo transesterification. As an example, and not to be limiting, exemplary coupler components that generate a primary alcohol include certain cyclic epoxies. Exemplary cyclic epoxies that generate a primary alcohol in the presence of a suitable catalyst have a structure according to Formula D.

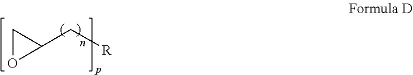

where n is greater than or equal to 1 and R can be any chemical group (including, but not limited to, ether, ester, phenyl, alkyl, alkynyl, etc.). In preferred aspects of the present disclosure, p is greater than or equal to 2 such that there are at least 2 of the epoxy structural groups present in the chain extender molecular. BADGE is an exemplary epoxy chain extender where R is bisphenol A, n is 1, and p is 2.

Other exemplary monomeric epoxy compounds include diglycidyl benzenedicarboxylate (Formula E) and triglycidyl benzene tricarboxylate (Formula F).

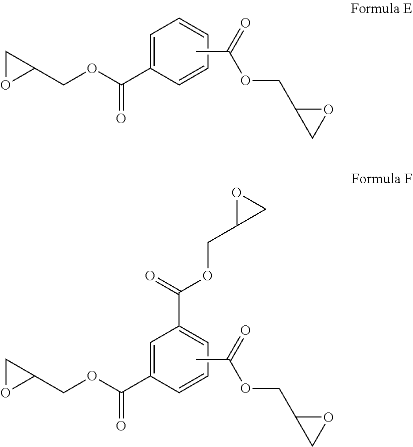

As noted herein, the coupler component is suitably reactive with the alcohol moiety present in the polyester chain component. Such linker components may include a dianhydride compound, such as a monomeric dianhydride compound. The dianhydride compound may facilitate network formation by undergoing direct esterification with the polyester component. In the presence of a suitable catalyst, the dianhydride can undergo ring opening, thereby generating carboxylic acid groups. The generated carboxylic acid groups undergo direct esterification with the alcohol groups of the polyester component.

An exemplary class of a monomeric linker component that is reactive with the alcohol moiety present in the ester oligomer includes dianhydrides. A preferred dianhydride is a pyromellitic dianhydride as provided in Formula G.

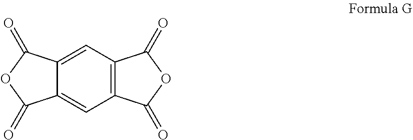 [SMILES: O=c1oc(=O)c2cc3c(=O)oc(=O)c3cc12]

As explained herein, the coupler component may comprise a polymeric composition. For example, the coupler component may comprise a component exhibiting reactivity with the carboxylic groups of the polyester component. These coupler components may include chain extenders having high epoxy functionality. High epoxy functionality can be characterized by the presence of between 200 and 300 equivalent per mol (eq/mol) of glycidyl epoxy groups.

An epoxidized styrene-acrylic copolymer, CESA, represents an exemplary polymeric coupler component. CESA is a copolymer of styrene, methyl methacrylate, and glycidyl methacrylate.

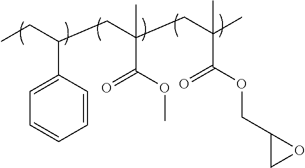

A preferred CESA according to the methods of the present disclosure has average molecular weight of about 6800 g/mol and an epoxy equivalent of 280 g/mol. As used herein, the epoxy equivalent is an expression of the epoxide content of a given compound. The epoxy equivalent is the number of epoxide equivalents in 1 kg of resin (eq./g).

In various aspects, the coupler component may comprise up to about 20 wt. % of the polymer composition. The coupler component may be present in an amount of up to about 20 wt. % based on the total weight of the composition, including representative values of about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. % and any combination of ranges there-between. In a specific example, the polymer composition comprises about 5 wt. % of the coupler component.

### Catalysts

As provided herein, the pre-dynamic cross-linked polymer composition may, in some aspects, comprise one or more catalysts, though this is not a requirement. The polyester component, coupler component, and non-networking component may be reacted in the presence of one or more suitable catalysts. Certain catalysts may be used to catalyze the reactions described herein. One or more catalysts may be used herein to facilitate the formation of a network throughout the compositions disclosed. In one aspect, a catalyst may be used to facilitate the ring opening reaction of epoxy groups of the epoxy chain extender with the carboxylic acid end-group of the ester oligomer component. This reaction effectively results in chain extension and growth of the ester oligomer component via condensation, as well as to the in-situ formation of additional alcohol groups along the oligomeric backbone of the ester oligomer component. Furthermore, such a catalyst may subsequently facilitate the reaction of the generated alcohol groups with the ester groups of the ester oligomer component (a process called transesterification), leading to network formation. When such a catalyst remains active, and when free alcohol groups are available in the resulting network, the continuous process of transesterification reactions leads to a dynamic polymer network.

As described herein, a catalyst may be considered a transesterification catalyst, a polycondensation catalyst, or, in some instances, both. That is, the at least one catalyst of the present disclosure may facilitate one or more of transesterification and polycondensation. Although certain catalysts may be sufficient for use as both a transesterification and a polycondensation catalyst, for simplification, the following description details certain aspects of the transesterification catalyst and the polycondensation catalyst separately. It is understood that such separation and description is intended for example only and is not intended to be limiting regarding the user of various catalysts in various aspects of the processes described herein.

### Transesterification Catalyst

An example catalyst, as described herein, may be considered a transesterification catalyst. Generally, a transesterification catalyst facilitates the exchange of an alkoxy group of an ester by another alcohol. The transesterification catalyst as used herein facilitates reaction of free alcohol groups with ester groups in the backbone of the ester oligomer or its final dynamic polymer network. As mentioned before, these free alcohol groups are generated in-situ in a previous step by the ring-opening reaction of the epoxy chain extender with the carboxylic acid end-groups of the ester oligomer component. Certain transesterification catalysts are known in the art and are usually chosen from metal salts, for example, acetylacetonates, of zinc, tin, magnesium, cobalt, calcium, titanium, and zirconium. In certain aspects, the transesterification catalyst(s) is used in an amount up to about 25 wt. %, for example, about 0.001 wt. % to about 25 wt. %, of the total molar amount of ester groups in the ester oligomer component. In some aspects, the transesterification catalyst is used in an amount of from about 0.001 wt. % to about 10 wt. % or from about 0.001 wt. % to less than about 5 wt. %. Preferred aspects include about 0.001, about 0.05, about 0.1, and about 0.2 wt. % of catalyst, based on the number of ester groups in the ester oligomer component.

Suitable transesterification catalysts are also described in Otera, J. Chem. Rev. 1993, 93, 1449-1470. Tests for determining whether a catalyst will be appropriate for a given polymer system within the scope of the disclosure are described in, for example, U.S. Published Application No. 2011/0319524 and in WO 2014/086974.

Tin compounds such as dibutyltinlaurate, tin octanoate, dibutyltin oxide, dioxtyltin, dibutyldimethoxytin, tetraphenyltin, tetrabutyl-2,3-dichlorodistannoxane, and all other stannoxanes are suitable catalysts. Rare earth salts of alkali metals and alkaline earth metals, particularly rare earth acetates, alkali metal and alkaline earth metals such as calcium acetate, zinc acetate, tin acetate, cobalt acetate, nickel acetate, lead acetate, lithium acetate, manganese acetate, sodium acetate, and cerium acetate are other catalysts that can be used. Salts of saturated or unsaturated fatty acids and metals, alkali metals, alkaline earth and rare earth metals, for example zinc stearate, are also suitable catalysts. The catalyst may also be an organic compound, such as benzyldimethylamide or benzyltrimethylammonium chloride. These catalysts are generally in solid form, and advantageously in the form of a finely divided powder. One preferred catalyst is zinc(II)acetylacetonate.

### Polycondensation Catalyst

In some aspects, the compositions of the present disclosure are prepared using a polycondensation catalyst. The polycondensation catalyst may increase the polymer chain length (and molecular weight) by facilitating the condensation reaction between alcohol and carboxylic acid end-groups of the ester oligomer component in an esterification reaction. Alternatively, this catalyst may facilitate the ring opening reaction of the epoxy groups in the epoxy chain extender with the carboxylic acid end-groups of the ester oligomer component. The polycondensation catalyst is used in an amount of between 10 ppm and 100 ppm with respect to the ester groups in the ester oligomer component. In some aspects, the polycondensation catalyst is used in an amount of from 10 ppm to 100 ppm or from 10 ppm to less than 75 ppm. Preferred aspects include 20 ppm, 30 ppm, 50 ppm of catalyst, based on the polyester component of the present disclosure. In a preferred aspect, the polycondensation catalyst is used in an amount of 50 ppm or about 0.005 wt. %.

Various titanium (Ti) based compounds have been proposed as polycondensation catalysts, because they are relatively inexpensive and safe. Described titanium-based catalysts include tetra-n-propyl titanate, tetraisopropyl titanate, tetra-n-butyl titanate, tetraphenyl titanate, tetracyclohexyl titanate, tetrabenzyl titanate, tetra-n-butyl titanate tetramer, titanium acetate, titanium glycolates, titanium oxalates, sodium or potassium titanates, titanium halides, titanate hexafluorides of potassium, manganese and ammonium, titanium acetylacetate, titanium alkoxides, titanate phosphites etc. The use of titanium based polycondensation catalysts in the production of polyesters has been described in EP0699700, U.S. Pat. No. 3,962,189, JP52062398, U.S. Pat. Nos. 6,372,879, and 6,143,837, for example. An exemplary titanium based polycondensation catalyst of the present disclosure is titanium(IV) isopropoxide, also known as tetraisopropyl titanate.

Other transesterification or polycondensation catalysts that can be used include metal oxides such as zinc oxide, antimony oxide, and indium oxide; metal alkoxides such as titanium tetrabutoxide, titanium propoxide, titanium isopropoxide, titanium ethoxide, zirconium alkoxides, niobium alkoxides, tantalum alkoxides; alkali metals; alkaline earth metals, rare earth alcoholates and metal hydroxides, for example sodium alcoholate, sodium methoxide, potassium alkoxide, and lithium alkoxide, sulfonic acids such as sulfuric acid, methane sulfonic acid, paratoluene sulfonic acid, phosphines such as triphenylphosphine, dimethylphenylphosphine, methyldiphenylphosphine, triterbutylphosphine, and phosphazenes. In certain aspects the catalyst is an aluminum phosphinate catalyst, such as but not limited to Exolit® OP1240, available from Clariant.

### Additives

One or more additives may be combined with the components of the dynamic or pre-dynamic cross-linked polymer to impart certain properties to the polymer composition. Exemplary additives include: one or more polymers, ultraviolet agents, ultraviolet stabilizers, heat stabilizers, antistatic agents, anti-microbial agents, anti-drip agents, radiation stabilizers, pigments, dyes, fibers, fillers, plasticizers, non-networking flame retardants, antioxidants, lubricants, impact modifiers, wood, glass, and metals, and combinations thereof. One or more networking impact modifier additives may be included in the composition. The coupler component (i.e., a polyester component), a transesterification catalyst, and a networking impact modifier additive may be combined in the presence of a catalyst at a temperature and for a time sufficient to form a dynamic cross-linked polymer composition with improved impact performance.

The one or more additives provided herein may include a networking impact modifier additive. As an example, a networking impact modifier may form dynamic covalent bonds with one or more of the carboxylic acid end groups or terminal hydroxyl groups of the chain component comprising a polyester. The speed and efficiency with which a given impact modifier reacts with the foregoing end groups of the polyester component may determine how well the impact modifier is incorporated throughout the polymer composition and ultimately affect impact performance.

In various aspects, the networking impact modifier may be incompatible with the polyester component of the composition. Thus, the addition of the networking impact modifier additive may give rise to a dispersed phase throughout the polymer composition. In a specific example, the dispersed phase comprises an amorphous and/or crystalline component.

Suitable networking impact modifier additives include at least two functional groups per chain that can exhibit reactivity with polymer end groups of the chain component to thereby facilitate incorporation into the network of the polymer composition. These networking impact modifier additives also exhibit a glass transition temperature T_{g} that is less than the temperature for the intended use of the polymer composition. Exemplary networking impact modifiers exhibit the foregoing properties and may include, but are not limited to, the following species: ethylene copolymers, high molecular weight elastomeric materials derived from olefins, monovinyl aromatic copolymers, silicone rubber impact modifiers with epoxy end groups, acrylic and methacrylic acids and their ester derivatives, as well as conjugated dienes that are fully or partially hydrogenated. The elastomeric materials can be in the form of homopolymers or copolymers, including random, block, radial block, graft, and core-shell copolymers.

In one example, the networking impact modifier may include an epoxy-functionalized polymer or (co)polymer. The epoxy-functionalized copolymer may form covalent bonds with one or more of the carboxylic acid end groups or terminal hydroxyl groups of the polyester component. In one example, the networking impact modifier may comprise a glycidyl methacrylate (GMA) poly(ethylene-acrylate) copolymer, commercially available as Lotader® AX8900. Specifically, the GMA poly(ethylene-acrylate) copolymer may comprise about 24% by weight methyl acrylate, 8% by weight glycidyl methacrylate, and about 68% by weight ethylene. During reactive compounding of the polyester component, coupler component, and a GMA poly(ethylene-acrylate) copolymer as the networking impact modifier, in the presence of a suitable catalyst, GMA may react with the terminal carboxylic acid or hydroxyl groups of the polyester component.

In a further example, the networking impact modifier additive may include a maleic anhydride (MA) copolymer. The maleic anhydride copolymer may form covalent bonds with one or more of the carboxylic acid end groups or the terminal hydroxyl groups of the polyester component. More specifically, the networking impact modifier additive may comprise a maleic anhydride poly(ethylene-acrylate) copolymer available as Lotader® 3430. Specifically, the MA poly(ethylene-acrylate) copolymer may comprise about 15% by weight methyl acrylate, about 3.1% by weight maleic anhydride, and about 81.9% by weight ethylene.

It is noted that the reaction between maleic anhydride and the terminal hydroxyl groups or carboxylic acid groups of the polyester component may proceed more slowly than the reaction of the GMA with the same groups of the polyester component. Thus, the MA poly(ethylene-acrylate) copolymer may be referred to as a comparatively slow reactive networking impact modifier while the GMA poly(ethylene-acrylate) copolymer may be referred to as a fast reactive networking impact modifier. Moreover, the speed and efficiency at which the networking impact modifier is able to react with the polyester end groups may determine how well the impact modifier is incorporated into the pre-dynamic or dynamic polymer composition. The more reactive the networking impact modifier with the end groups of the polyester component, the faster the reaction occurs and the more complete its incorporation throughout the polymer composition at reactive sites. More incorporation throughout the polymer composition may also ensure better dispersion of the networking impact modifier in the polymer composition. With more dispersion, the impact modifier domain sizes are smaller ultimately improving the impact performance of the polymer composition.

MA- and GMA-poly(ethylene-acrylate) copolymers may phase separate from the polyester component thereby creating a rubbery dispersed phase which functions as the impact modifier for the system. MA- and GMA-poly(ethylene-acrylate) copolymers also comprise considerable amounts of ethylene copolymer (i.e., about 68% by weight and 81.9% by weight, respectively, as provided above). These amounts of ethylene copolymer may impart a certain degree of crystallinity throughout the rubbery impact phase.

Without being bound by any particular theory, one skilled in the art may understand that semi-crystalline blocks or domains in a given material may alter impact properties via (micro-)phase separation. It has been found that a triblock copolymer consisting of polystyrene (PS), polybutadiene (PB) and poly(ε-caprolactone) (PCL) blocks exhibited significant improvement of elongation at break where semi-crystalline PCL is incorporated into the copolymer with the PCL creating micro-domains. Meanwhile, the overall morphology of the polymer matrix material remained essentially unchanged. The impact properties of these materials were also shown to be altered by inducing pre-cavitation using thermally induced stresses by fractionated crystallization. Balsamo, et. al., Macromolecules (1999) 32, 1226-1232.

The networking impact modifier additive may form a crystalline phase throughout the dispersed rubbery phase. In one example, ethylene copolymers present in the networking impact modifiers my cause a certain degree of crystallinity within the dispersed rubbery phase. As provided above, it has been shown that (micro-) phase separation of a crystalline phase inside a rubbery matrix has a beneficial influence on delocalization of stresses inside a given material, thereby toughening an intrinsically brittle material, such as PBT, through a process called “cavitation.” Cavitation may refer to a mismatch in the deformation of the interphase between a dispersed phase and the matrix throughout which it is dispersed because crystallization of the dispersed phase creates interfacial stresses. Subsequently, upon loading of a material that induces cavitation, energy can be dissipated through the formation of micro-crazes, efficiently reducing the failure (or breakage due to stress) of the material.

The amount of cavitation may directly influence the amount of interfacial stress within a given material. Because this cavitation is related to the crystallization of the dispersed phase, impact properties of PBT-based DCN materials with certain networking impact modifiers should be affected by controlling certain crystallization parameters of the impact modifier phase throughout the PBT-based DCN. For example, varying the cooling protocol, or establishing a faster cooling rate, may improve ductility by increasing cavitation. Literature has shown that the quenching of poly(ε-caprolactone) PCL domains inside a polystyrene PS-polybutadiene PB-PCL copolymer material led to significant improvement of the elongation at break. Specifically, samples showed an improvement of nearly 900% when a film of the copolymer material was quenched in liquid nitrogen (Ns) versus 58% for a solvent-casted film.

In one aspect, the networking impact modifier may comprise an epoxy-functionalized silicone rubber impact modifier. As an example, the silicone rubber impact modifier may comprise epoxy end groups as presented in Formula H.

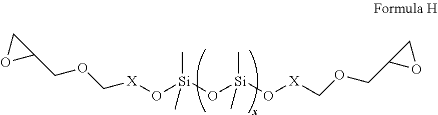

Glycidyl epoxy ethers may also be applied in networking impact modifiers. These ethers may be similar to the exemplary coupler component D.E.R. 671 (a bisphenol A diglycidyl ether) wherein the bisphenol A species is instead any one of the following species, for example: olefins, monovinyl aromatic copolymers, acrylic and methacrylic acids and their ester derivatives, as well as conjugated dienes that are fully or partially hydrogenated, described above.

The networking impact modifier may be present in an amount between about 2 wt. % and about 20 wt. % based on the total weight of the composition, including representative values of about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. % and any combination of ranges there-between. In some aspects, the networking impact modifier may be present in an amount between about 5 wt. % and about 20 wt. % based on the total weight of the composition. For example, the networking impact modifier may be present in an amount of about 10 wt. % or 15 wt. % based on the total weight of the composition.

With addition of a suitable networking impact modifier to the polymer composition, the resulting amount of dispersed phase may be governed by the amount of impact modifier introduced. Moreover, the amount of crystalline phase, where applicable, is varying and may depend upon the structure and composition of the impact modifier.

In further examples, the compositions described herein may comprise a UV stabilizer for dispersing UV radiation energy. The UV stabilizer does not substantially hinder or prevent cross-linking of the various components of the compositions described herein. UV stabilizers may be hydroxybenzophenones, hydroxyphenyl benzotriazoles, cyanoacrylates, oxanilides, or hydroxyphenyl triazines. The compositions described herein may comprise heat stabilizers. Exemplary heat stabilizer additives include, for example, organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like; phosphates such as trimethyl phosphate, or the like; or combinations thereof.

The compositions described herein may comprise an antistatic agent. Examples of monomeric antistatic agents may include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

The compositions described herein may comprise anti-drip agents. The anti-drip agent may be a fibril forming or non-fibril forming fluoropolymer such as polytetrafluoroethylene (PTFE). The anti-drip agent can be encapsulated by a rigid copolymer as described above, for example styrene-acrylonitrile copolymer (SAN). PTFE encapsulated in SAN is known as TSAN. Encapsulated fluoropolymers can be made by polymerizing the encapsulating polymer in the presence of the fluoropolymer, for example an aqueous dispersion. TSAN can provide significant advantages over PTFE, in that TSAN can be more readily dispersed in the composition. An exemplary TSAN can comprise 50 wt % PTFE and 50 wt % SAN, based on the total weight of the encapsulated fluoropolymer. The SAN can comprise, for example, 75 wt % styrene and 25 wt % acrylonitrile based on the total weight of the copolymer. A SAN may comprise, e.g., from 50-99 wt % styrene, and from about 1 to about 50 wt % acrylonitrile, including all intermediate values. Alternatively, the fluoropolymer can be pre-blended in some manner with a second polymer, such as for, example, an aromatic polycarbonate or SAN to form an agglomerated material for use as an anti-drip agent. Either method can be used to produce an encapsulated fluoropolymer.

Exemplary fibers include glass fibers, carbon fibers, polyester fibers, polyamide fibers, aramid fibers, cellulose and nanocellulose fibers or plant fibers (linseed, hemp, sisal, bamboo, etc.) may also be envisaged. In some aspects, the pre-dynamic cross-linked compositions described herein may comprise a glass fiber filler or other fiber filler. The glass fiber filler may have a diameter of about 1-25 micrometers (μm) and all intermediate values.

Suitable fillers for the compositions described herein include: silica, clays, calcium carbonate, carbon black, kaolin, and whiskers. Other possible fillers include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO2, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

Plasticizers, lubricants, and mold release agents can be included. Mold release agent (MRA) allows the material to be removed quickly and effectively. Mold releases can reduce cycle times, defects, and browning of finished product. There is a considerable overlap among these types of materials, which may include, for example, phthalic acid esters; tristearin; di- or polyfunctional aromatic phosphates; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate (PETS), and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a suitable solvent; waxes such as beeswax, montan wax, paraffin wax, or the like.

Exemplary antioxidant additives include organophosphites such as tris(nonyl phenyl)phosphite, tris(2,4-di-t-butylphenyl)phosphite (“IRGAFOS 168” or “I-168”), bis(2,4-di-t-butylphenyl)pentaerythritol diphosphite, distearyl pentaerythritol diphosphite, tris(dialkylaryl)phosphite, e.g., tris(di-t-butylphenyl)phosphite or tris(di-t-amylphenyl)phosphite, and the bis(dialkylaryl)monoalkylaryl phosphite, e.g., bis(di-t-butylphenyl)mono-t-butylphenyl phosphite or bis(di-t-amylphenyl)mono-t-amylphenyl phosphite, or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants.

### Articles and Processes

Articles can be formed from the compositions described herein. Generally, the ester oligomer component, the monomeric chain extender, and the transesterification and polycondensation catalysts are combined and heated to provide a molten mixture which is reacted under decreased pressure to form the dynamic cross-linked compositions described herein. The compositions described herein can then form, shaped, molded, or extruded into a desired shape. The term “article” refers to the compositions described herein being formed into a particular shape. As an example, articles may be formed from the dynamic cross-linked polymer compositions of the present disclosure and may include composites, a thermoformed material, or a combination thereof. The articles may further comprise a solder bonded to the formed article. It is understood that such examples are not intended to be limiting, but are illustrative in nature. It is understood that the subject compositions may be used for various articles and end-use applications.

With thermosetting resins of the prior art, once the resin has hardened (i.e. reached or exceeded the gel point), the article can no longer be transformed or repaired or recycled. Applying a moderate temperature to such an article does not lead to any observable or measurable transformation, and the application of a very high temperature leads to degradation of this article. In contrast, articles formed from the dynamic cross-linked polymer compositions described herein, on account of their particular composition, can be transformed, repaired, or recycled by raising the temperature of the article.

From a practical point of view, this means that over a broad temperature range, the article can be deformed, with internal constraints being removed at higher temperatures. Without being bound by theory, it is believed that transesterification exchanges in the dynamic cross-linked polymer compositions are the cause of the relaxation of constraints and of the variation in viscosity at high temperatures. In terms of application, these materials can be treated at high temperatures, where a low viscosity allows injection or molding in a press. It should be noted that, contrary to Diels-Alder reactions, no depolymerization is observed at high temperatures and the material conserves its cross-linked structure. This property allows the repair of two parts of an article. No mold is necessary to maintain the shape of the components during the repair process at high temperatures. Similarly, components can be transformed by application of a mechanical force to only one part of an article without the need for a mold, since the material does not flow.

Raising the temperature of the article can be performed by any known means such as heating by conduction, convection, induction, spot heating, infrared, microwave or radiant heating. Devices for increasing the temperature of the article in order to perform the processes of described herein can include: an oven, a microwave oven, a heating resistance, a flame, an exothermic chemical reaction, a laser beam, a hot iron, a hot-air gun, an ultrasonication tank, a heating punch, etc. The temperature increase can be performed in discrete stages, with their duration adapted to the expected result.

Although the dynamic cross-linked polymer compositions do not flow during the transformation, by means of the transesterification reactions, by selecting an appropriate temperature, heating time and cooling conditions, the new shape may be free of any residual internal constraints. The newly shaped dynamic cross-linked polymer compositions are thus not embrittled or fractured by the application of the mechanical force. Furthermore, the article will not return to its original shape. Specifically, the transesterification reactions that take place at high temperature promote a reorganization of the cross-link points of the polymer network so as to remove any stresses caused by application of the mechanical force. A sufficient heating time makes it possible to completely cancel these stresses internal to the material that have been caused by the application of the external mechanical force. This makes it possible to obtain stable complex shapes, which are difficult or even impossible to obtain by molding, by starting with simpler elemental shapes and applying mechanical force to obtain the desired more complex final shape. Notably, it is very difficult to obtain by molding shapes resulting from twisting. An article made from a dynamic cross-linked polymer composition can be heated and deformed, and upon returning to the original temperature, maintains the deformed shape. As such, articles in accordance with the present disclosure may comprise a shape generated by applying mechanical forces to a molded piece formed from the dynamic cross-linked polymer composition.

According to one variant, a process for obtaining and/or repairing an article based on a dynamic cross-linked polymer composition described herein comprises: placing in contact with each other two articles formed from a dynamic cross-linked polymer composition; and heating the two articles so as to obtain a single article. The heating temperature (T) is generally within the range from 50° C. to 250° C., including from 100° C. to 200° C.

An article made of dynamic cross-linked polymer compositions as described herein may also be recycled by direct treatment of the article, for example, the broken or damaged article is repaired by means of a transformation process as described above and may thus regain its prior working function or another function. Alternatively, the article is reduced to particles by application of mechanical grinding, and the particles thus obtained may then be used to manufacture a new article.

The networking impact modifier additive may provide advantageous properties when compared to a non-reactive or non-networking impact modifier component. Such a networking impact modifier additive may improve impact strength performance without suffering degradation during the post-curing process.

In a specific example, where the networking impact modifier comprises an epoxy-functionalized (co)polymer such as the fast reactive GMA poly(ethylene-acrylate) copolymer, the dynamically cross-linked polymer composition may exhibit an unnotched and a notched Izod impact strength greater than those of a corresponding composition free of the networking impact modifier additive. Further, the dynamically cross-linked polymer composition may exhibit an unnotched Izod impact strength within about 5% of the unnotched impact strength of a corresponding composition comprising a non-networking MBS core-shell impact modifier composition at about 7 wt % of that corresponding composition and the MBS core-shell impact modifier containing about 78 wt % soft phase and free of the networking impact modifier additive. Where the networking impact modifier comprises the GMA poly(ethylene-acrylate) copolymer, the dynamically cross-linked polymer composition may exhibit a notched Izod impact strength that is greater than a notched Izod impact strength of a corresponding composition comprising a non-networking MBS core-shell impact modifier composition at about 7 wt % of that corresponding composition and the MBS core-shell impact modifier containing about 78 wt % soft phase and free of the networking impact modifier additive,

In a further example, where the networking impact modifier comprises a slow reactive networking impact modifier such as the MA poly(ethylene-acrylate) copolymer, the resulting dynamically cross-linked polymer composition may exhibit an unnotched Izod impact strength greater than the unnotched impact strength of a corresponding composition in the absence of the networking impact modifier additive.

Pre-dynamic and dynamic cross-linked compositions of the present disclosure are useful in soldering applications. For example, the disclosed compositions may be used in workpieces that comprise a solder bonded to at least one component comprising a dynamic cross-linked polymer composition.

As used herein, the term “solder” may refer to a fusible metal composition, such an alloy, that is used to join one or more components to one another. Solders can be lead-based solders. Preferred lead-based solders comprise tin and lead. Typically, such solders comprise between 30 wt. % and 95 wt. %, or between about 30 wt. % and about 95 wt. %, of lead. Solders used in the disclosure can alternatively be lead-free solders. Lead-free solders can comprise tin, copper, silver, bismuth, indium, zinc, antimony, or a combination thereof. Preferred lead-free solders comprise tin, silver, and copper. Other solders useful in the present disclosure include those comprising tin, zinc, and copper; lead, tin, and antimony; tin, lead, and zinc; tin, lead, and zinc; tin, lead, and copper; tin, lead, and phosphorous; tin, lead, and copper; and lead, tin, and silver. As used herein, lead-free may be defined according to the Restriction of Hazardous Substances in Electrical and Electronic Equipment (RoHS) Directive (2002/95/EC) which provides that lead content is less than 0.1% by weight in accordance with IPC/EIA J-STD-006).

### Aspects of the Disclosure

In various aspects, the present disclosure pertains to and includes at least the following aspects.

Aspect 1: A polymer composition, comprising, consisting of, or consisting essentially of:
a pre-dynamic cross-linked polymer composition comprising polyester chains joined by a coupler component; and
one or more networking impact modifier additives.

Aspect 2: The polymer composition of aspect 1, wherein the pre-dynamic cross-linked polymer composition is produced by reacting at least a coupler component comprising at least two reactive groups with a chain component comprising a polyester and with one or more networking impact modifier additives, in the presence of one or more catalysts.

Aspect 3: The polymer composition of any of Aspects 1-2, wherein the one or more networking impact modifier additives forms dynamic covalent bonds with one or more of carboxylic acid end groups or terminal hydroxyl groups of the polyester chains polymer composition.

Aspect 4: The polymer composition of any of Aspects 1-3, wherein the composition, when subjected to a curing process, forms a dynamic cross-linked polymer composition that (a) has a plateau modulus of from about 0.01 MPa to about 1000 MPa when measured by dynamic mechanical analysis at a temperature above a melting temperature of the polyester chains of the pre-dynamic cross-linked composition and (b) exhibits a capability of relaxing internal residual stresses at a characteristic timescale of between 0.1 and 100,000 seconds above a glass transition temperature of the polyester chains, as measured by stress relaxation rheology measurement.

Aspect 5: The polymer composition of Aspect 4, wherein the curing process comprises heating the pre-dynamic cross-linked composition to a temperature of from about 170° C. to about 250° C. for up to about 8 hours.

Aspect 6: The polymer composition of any of Aspects 4-5, wherein the one or more networking impact modifier additives further comprises an epoxy-functionalized (co)polymer.

Aspect 7: The polymer composition of Aspect 6, wherein the epoxy-functionalized (co)polymer comprises a glycidyl methacrylate poly(ethylene-acrylate) copolymer.

Aspect 8: The polymer composition of any of Aspects 4-5, wherein the one or more networking impact modifier additives further comprises a maleic anhydride copolymer.

Aspect 9: The polymer composition of Aspect 8, wherein the maleic anhydride copolymer is a maleic anhydride poly(ethylene-acrylate) copolymer.

Aspect 10: The polymer composition of any of Aspects 1-9, wherein the one or more networking impact modifier additives is present in an amount between 2 wt. % and 20 wt. %.

Aspect 11: A method of preparing a pre-dynamic cross-linked polymer composition, comprising, consisting of, or consisting essentially of:
reacting (a) a coupler component and (b) a chain component comprising a polyester having one or more reactive end groups; and
adding one or more networking impact modifier additives comprising one or more groups reactive with the one or more reactive end groups of the chain component, under such conditions that the one or more networking impact modifier additives covalently bond to the one or more reactive end groups of the chain component,
the reacting being performed in the presence of at least one catalyst that promotes formation of the pre-dynamic cross-linked composition, and
the pre-dynamic cross-linked composition when subjected to a curing process (a) exhibits a plateau modulus of from about 0.01 MPa to about 1000 MPa when measured by dynamic mechanical analysis at a temperature above a melting temperature of the polyester of the pre-dynamic cross-linked composition and (b) exhibits a capability of relaxing internal residual stresses at a characteristic timescale of between 0.1 and 100,000 seconds above a glass transition temperature of the polyester, as measured by stress relaxation rheology measurement.

Aspect 12: The method of Aspect 11, further comprising a curing process that comprises heating the pre-dynamic cross-linked composition of from about 170° C. to about 250° C. for up to about 8 hours to form a dynamically cross-linked composition.

Aspect 13: The method of any of Aspects 11-12, wherein the one or more networking impact modifier additives comprises a maleic anhydride poly(ethylene-acrylate) copolymer or a glycidyl methacrylate poly(ethylene-acrylate) copolymer.

Aspect 14: The method of any of Aspects 11-13, wherein the one or more networking impact modifier additives is present in an amount between 2 wt. % and 20 wt. %.

Aspect 15: The method of any of Aspects 11-14, wherein the reacting occurs at a temperature in which the chain component is in a melted state.

Aspect 16: The method of any of Aspects 11-15, wherein the one or more networking impact modifier additives forms dynamic covalent bonds with one carboxylic acid end groups or terminal hydroxyl groups of the chain component.

Aspect 17: The method of any of Aspects 11-16, wherein the one or more networking impact modifier additives gives rise to a dispersed phase throughout the polymer composition within which the one or more impact modifier additives is dispersed.

Aspect 18: A method of forming an article that comprises a pre-dynamic cross-linked polymer composition, comprising, consisting of, or consisting essentially of:
preparing a pre-dynamic cross-linked polymer composition according to the method of any of Aspects 11-17; and
subjecting the pre-dynamic cross-linked polymer composition to one or more of a compression molding process, a profile extrusion process, or a blow molding process so as to form the article.

Aspect 19: A method of forming an article that comprises a pre-dynamic cross-linked polymer composition, comprising, consisting of, or consisting essentially of:
subjecting the pre-dynamic cross-linked polymer composition according to any of Aspects 11-18 to one or more of a compression molding process, a profile extrusion process, or a blow molding process so as to form the article.

Aspect 20: The method of Aspect 19, further comprising subjecting the pre-dynamic cross-linked polymer composition to a curing process that comprises heating the pre-dynamic cross-linked composition of from about 170° C. to about 250° C. for up to about 8 hours to form a dynamically cross-linked composition.

The following examples are provided to illustrate the compositions, processes, and properties of the present disclosure. The examples are merely illustrative and are not intended to limit the disclosure to the materials, conditions, or process parameters set forth therein.

### EXAMPLES

### Materials

PBT315 (molecular weight 110,000) (SABIC), milled
D.E.R.™ 671 (a solid epoxy resin that is the reaction product of epichlorohydrin and bisphenol A) (Dow Benelux B.V.)
Zinc(II)acetylacetonate (H2O) (Acros)
ULTRANOX™ 1010 (an antioxidant) (BASF)
Zinc(II)acetylacetonate (Zn(AcAc)₂, H₂O) (Acros)
Polyethylene (PE)
Tris(di-t-butylphenyl)phosphite (processing aid/stabilizer)
Polyethylene tetrastearate (PETS, >90% esterified)
Glass fiber (10 micrometer, μm)
Lotader® AX8900 (Arkema) (glycidyl methacrylate GMA containing poly(ethylene-acrylate) copolymer)
Lotader® 3430 (Arkema) (maleic anhydride MA containing poly(ethylene-acrylate) copolymer
Paraloid™ EXL2650J (methacrylate-butadiene-styrene MBS core shell rubber, 78% by weight of butadiene soft phase rubber)

### Formation of Pre-Dynamic Cross-Linked Polymer and Dynamic Cross-Linked Compositions

The foregoing materials were used to prepare pre-dynamic compositions. Samples comprising the formulations were prepared by blending the materials described herein, reactive extrusion, injection molding of the extruded compounds, and then post-cured before testing. Post-curing comprised heating the molded specimen for 2 to 4 hours at 190° C. to 200° C.

Various formulations were compounded using a Werner & Pfleiderer Extruder ZSK 25 mm co-rotating twin screw extruder with a melt temperature of 240° C. to 280° C., an output of 20 kilograms per hour (kg/h), and 300 revolutions per minute (rpm) and pelletized. The residence time in the extruder was less than about 30 seconds. A portion of each sample was post-cured to form the fully dynamic cross-linked compositions as described herein. Subsequently, the required test specimen were prepared by injection molding on an Engel 45 ton injection mold machine and post-cured to complete dynamic network formation prior to testing. Post-curing was performed by heating the sample a temperature close to, but below, the melting temperature (Tₘ) of the polyester component. The post-curing temperatures used were 190° C. to 200° C. for the PBT-DCN samples. It is noted that the melting point for the PBT used in this illustrative example was about 223° C. The post-cured granulates obtained adhered to each other, but could be separated with minimal force.

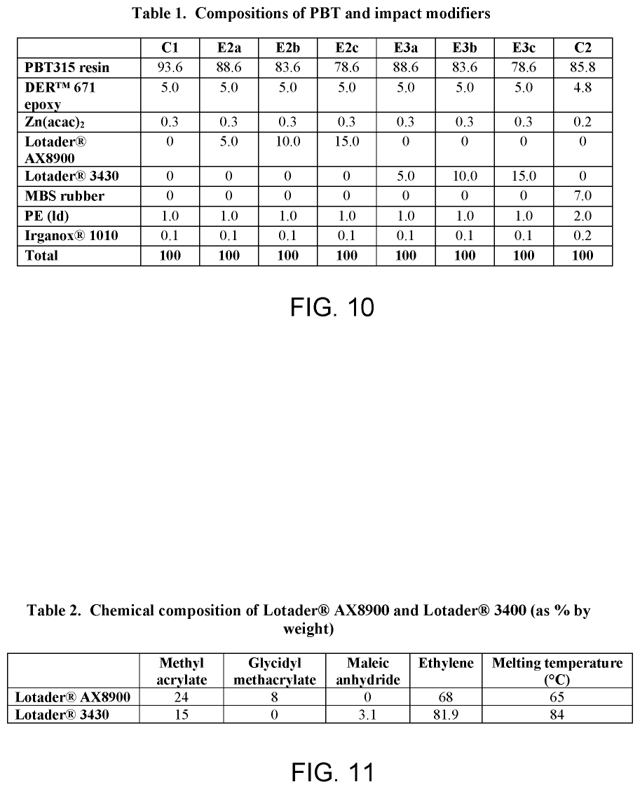

Table 1 presents the formulations for comparative samples C1 and C2 and inventive samples E2a through E2c and E3a through E3c. Each sample is prepared as described above including any additional components as provided in Table 1 as shown in FIG. 10.

Comparative sample C1 is a standard reference formulation for PBT-based DCN compositions formed with D.E.R.™ 671 as the coupler component. Comparative sample C2 is a PBT-based DCN formulation containing non-reactive core/shell MBS rubber impact modifier particles. To prevent degradation of the MBS rubber impact modifier in the PBT-DCN sample, comparative sample C2 was not subjected to a post-curing step after injection molding to form test specimen. Instead, C2 was prepared by blending the materials described herein, reactive extrusion to form pellets, post-curing the pellets, and finally injection molding the pellets to form the testing specimen.

Inventive samples E2a, E2b, and E2c are PBT-based DCN formulations including varying amounts (5, 10, and 15 wt. % based on the total weight of the composition) of Lotader® AX8900 as a reactive impact modifier additive. Lotader® AX8900 is a GMA containing poly(ethylene-acrylate) copolymer that exhibits reactivity with PBT during reactive compounding. Inventive samples E3a, E3b, and E3c are PBT-based DCN formulations including varying amounts of Lotader® 3430 (5, 10, and 15 wt. %) containing poly(ethylene-acrylate) copolymer reactive impact modifier additive. Specifically, the Lotader® 3430 also exhibits reactivity with PBT during reactive compounding. Table 2 as shown in FIG. 11 presents the chemical composition and species content for Lotader® AX8900 and Lotader® 3400 as percent by weight.

The Lotader® additives are incompatible with the PBT matrix and thus will phase out of the resin matrix creating a rubbery dispersed phase. The dispersed rubbery phase acts as an impact modifier for the PBT-DCN system. The reaction of GMA or MA groups of the Lotader® impact modifier chemically interacts with the carboxylic acid or hydroxyl end-groups of the PBT, respectively. It may also be speculated that a reduction in Lotader® chain mobility may reduce the extent of phase separation and create smaller impact modifier domains.

It is hypothesized that the GMA epoxy groups of the Lotader® AX8900 resin react with the terminal carboxylic acid groups of PBT315 to create a covalently bound impact modifier group. Lotader® 3430 impact modifier contains MA as reactive group, instead of GMA. It is theorized that this MA impact modifier may also be incorporated chemically, by reaction of the MA groups with terminal hydroxyl groups of PBT. However, the reaction of MA with hydroxyl under the experimental conditions employed here is slower than the reaction of GMA with carboxylic acid end-groups in inventive samples E2a-E2c. As provided herein, the MA impact modifier (Lotader® 3430) may be considered a slow reactive impact modifier in comparison to the GMA impact modifier (Lotader® AX8900) which may be considered a fast impact modifier in comparison. Compared to Lotader® AX8900 and 3430, the MBS rubber is considered non-reactive.

### General Testing Methods

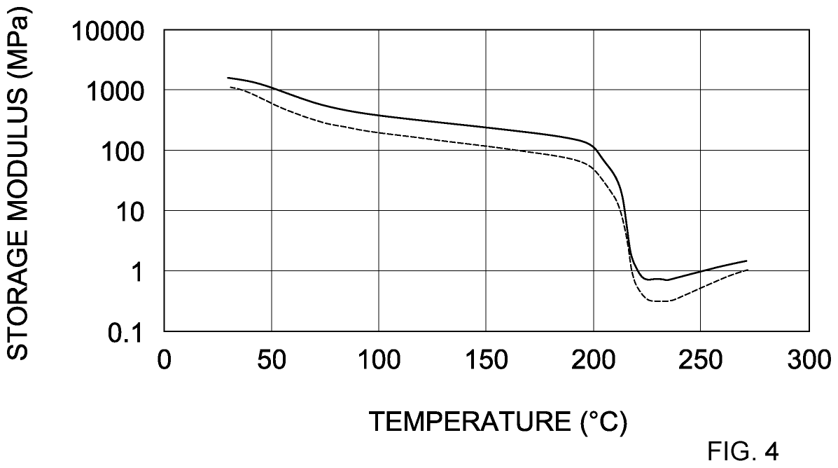

Dynamic Mechanical Analysis (DMA) and stress relaxation rheology (SR) measurements were performed on selected samples from the Examples listed above. It is known that the addition of a bifunctional epoxy and transesterification catalyst to a PBT formulation generates a dynamically cross-linked network composition (as in C1). The dynamically cross-linked nature of a material can be verified using a combination of DMA and SR measurements. In DMA, semi-crystalline DCN material exhibits a plateau value for the storage modulus at temperatures higher than the melting temperature of the resin matrix (here, PBT).—The plateau at these temperatures indicates a continued solid-like behavior of the material even though it is in a melt state. Cross-linked materials generally exhibit this behavior. FIG. 4 presents DMA curves for E2a and E2c (Lotader® AX8900 at 5 wt. % and 15 wt. %, respectively). As shown, both samples have a plateau modulus above the melting temperature of the PBT resin matrix (i.e., PBT melting temperature is about 220° C.). At lower temperature, stress relaxes slower (gradual curve), while at elevated temperature network rearrangement becomes more active and so stress relaxes faster (steeper curve). Thus, samples E2a and E2c appear to possess a cross-linked network.

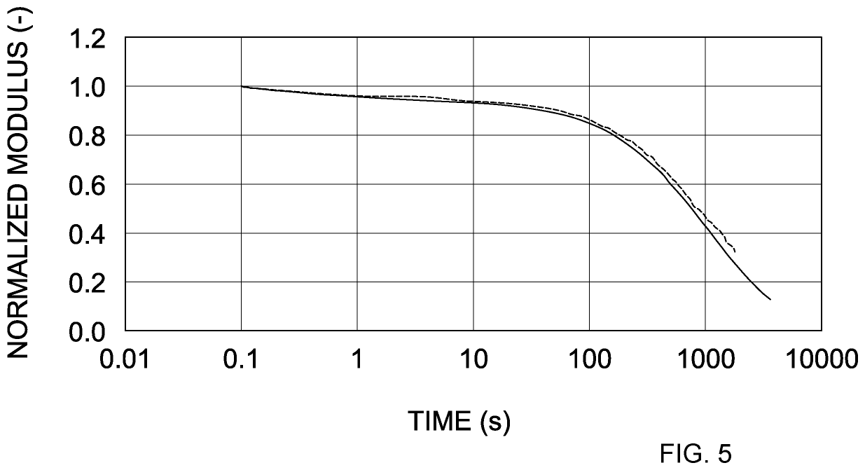

SR measurements exhibit relaxation of internal stresses imposed by deformation of the material by pre-straining. Stress relaxation occurs in this case by network exchange reactions. Conventional thermosets however do not show relaxation of stress since all cross-links are locked in place and cannot rearrange. Stress relaxation measurements were performed using an 8 mm parallel-plate geometry at a 3% strain with a fixed gap of 1 millimeter (mm). Measurements were performed at 250° C. Stress relaxation analyses were performed on selected samples in the linear viscoelastic regime. Typically, a thermoplastic relaxes fast in a short period of time, while a classic thermoset does not show obvious relaxation below the degradation temperature of the composition. For a DCN, thermoset behavior is expected at lower temperatures, but at higher temperatures relaxation and the relaxation time may be dependent on temperature (i.e., the higher the temperature, the shorter time relaxation time). FIG. 5 presents the SR curves for E2a and E2c. The inventive samples similarly exhibit the characteristic stress relaxation and timescales. As provided herein, the degree of stress relaxation is displayed as the normalized value of the storage modulus as a function of the experimental run time. Inventive samples E2a and E2c exhibited the characteristic network relaxation times τ₁* between 1200 and 1500 seconds.

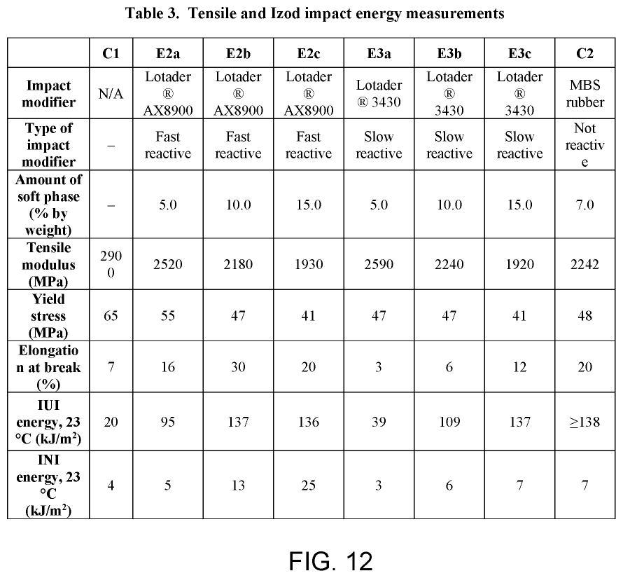

As the dynamic cross-linked behavior was confirmed for selected inventive samples, mechanical properties were also evaluated. A notched Izod impact (“NII”) test was carried out according to ISO 180. An unnotched Izod impact (“NII”) test was carried out according to ISO 180. Data units are kilojoule per square meter (kJ/m²). Tensile modulus was measured in accordance with ISO 527. Tensile strength for at yield stress (megapascals, MPa) and elongation at break (as a percent) were also observed. Results are presented in Table 3 as shown in FIG. 12. Table 3 also proves the impact modifier and its type as well as the amount of soft phase (as a percent by weight) present in each impact modifier.

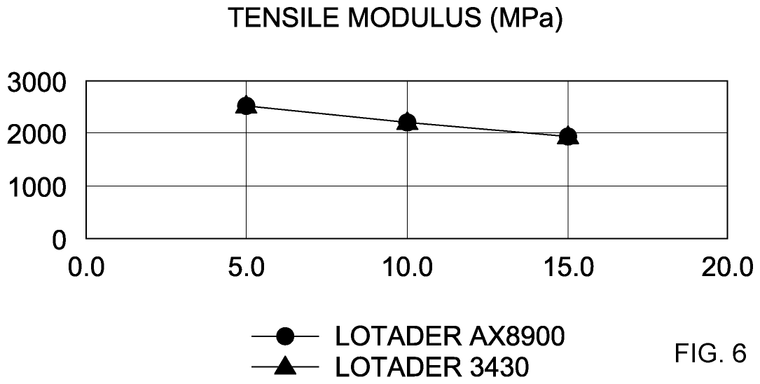

As provided in Table 3, the tensile modulus appears consistent among the different types of impact modifiers (i.e., Lotader® AX8900 (with GMA) vs. Lotader® 3430 (with MA) vs. MBS rubber). Tensile modifiers for the inventive samples at varying amounts of the Lotader® impact modifiers (E2a-E2c and E3a-E3c) are nearly identical for comparable amounts of the soft phase within the formulation. This behavior is presented in FIG. 6 wherein curves for the tensile modulus plotted as a function of the impact modifier content for Lotader® AX8900 and Lotader® 3430 appear to overlap. Similarly, the tensile modulus of comparative sample C4 comprising the non-reactive MBS rubber is also in the range of about 2000 MPa to about 2500 MPa.

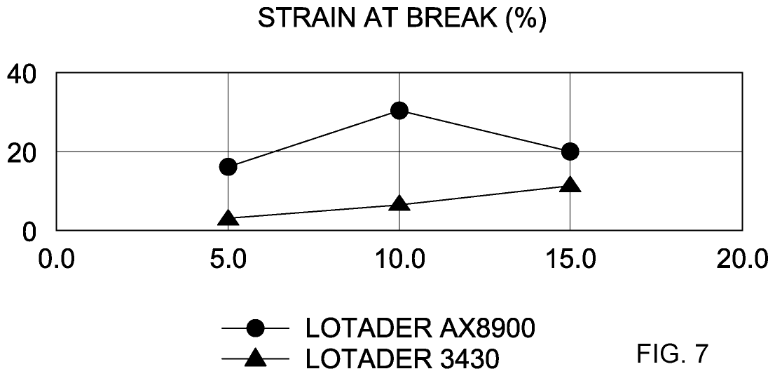

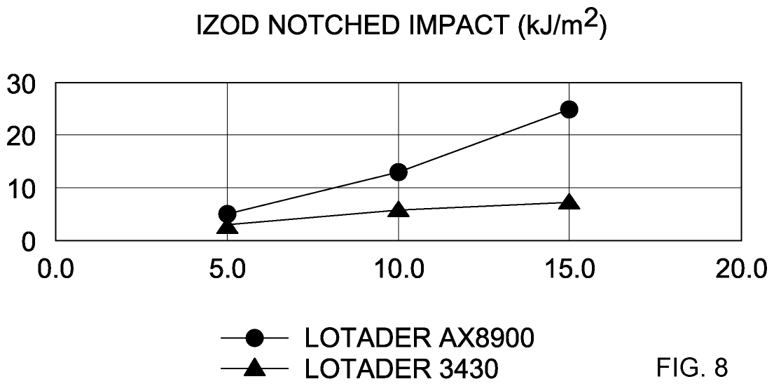

However, elongation at break and impact strength exhibited different behavior depending upon the impact modifier. For both elongation at break and impact strength, samples E2a through E2c (fast reactive Lotader® AX8900 with GMA) exhibited greater values than the corresponding values for E3a through E3c (slow reactive Lotader® 3430 with MA). In certain cases, the Lotader® 3430 samples also exhibited poorer results than comparative sample C1 (see, notched Izod for 5 wt. % Lotader® 3430) and poorer results than comparative sample C2 comprising the MBS non-reactive rubber (see, notched and unnotched Izod for 5 wt. % and 10 wt. % Lotader® 3430). FIGS. 7 and 8 present graphical representations of the elongation (strain) at break and notched Izod impact strength, respectively. When comparing the un-notched impact energies of all samples observed, it is seen that the Lotader® 3430 exhibits the poorest performance while Lotader® AX8900 and MBS rubber perform equally or at least similarly well. No break of the test specimen under the test conditions (as indicated by Izod un-notched impact energies of ≥138 kJ/m² was observed for comparative sample C2. However, the advantage of Lotader® AX8900 over the MBS rubber (E2a-E2c vs C2) in this case becomes apparent given the consideration that MBS rubber is thermally unstable, being prone towards oxidative degradation at post-curing conditions. As provided herein, the formulation of comparative sample C2 was prepared using post-cured pre-DCN compounded pellets. Upon an additional post-curing step after injection molding of test specimen, the Izod unnotched impact energy dropped to only 20-25 kJ/m². Conversely, the Lotader® AX8900 samples did not suffer from degradation and can be incorporated using a one-step compounding/injection molding process, followed by post-curing.

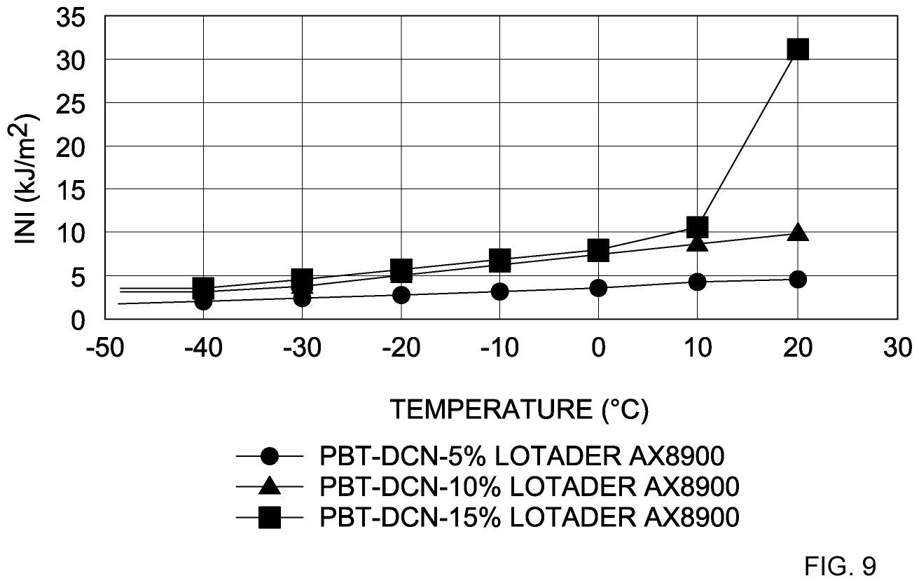

The notched Izod impact strength for the Lotader® AX8900 samples E2a through E2c were also observed at different temperatures from about −50° C. to about 30° C. As shown in FIG. 9, a ductile-brittle transition was apparent between 10° C. and 20° C. for the material with 15 wt. % Lotader® AX8900.

### ADDITIONAL EXAMPLES

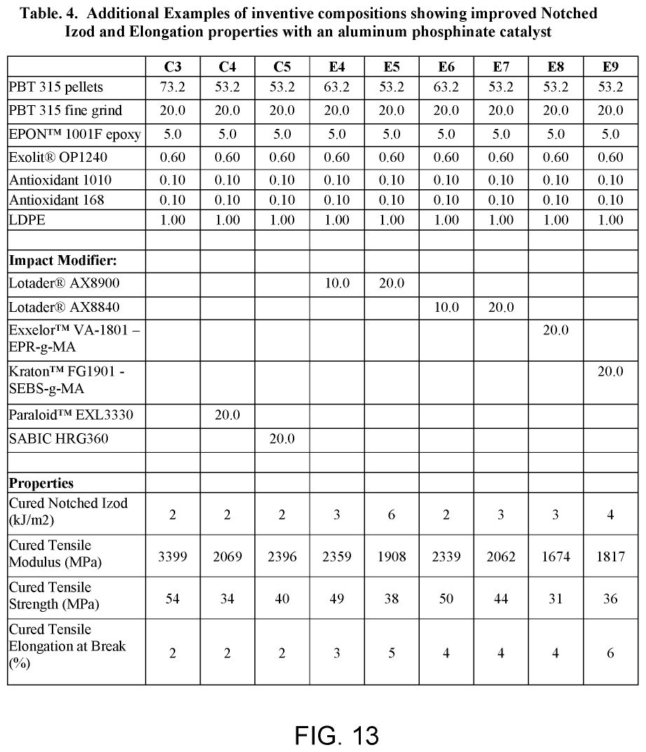

Additional examples of comparative and inventive compositions are provided in Table 4 as shown in FIG. 13. For each composition, blends of the ingredients were fed into the feed-throat and compounded on a Coperion ZSK 25 mm using the following process settings:

| | | | | | Z-6 | | | Parts |
|---|---|---|---|---|---|---|---|---|
| | | | | | to | | | per |
| Z-1 | Z-2 | Z-3 | Z-4 | Z-5 | Z-10 | Die | rpm | hundred |
| 25° C. | 25° C. | 225° C. | 250° C. | 250° C. | 245° C. | 245° C. | 300 | ≥40 |

Extruded strands were cooled using water-spray on a moving mesh belt and chopped into pellets with a rotary knife chopper. The pellets were injection molded into ISO test parts on a 55-Ton Milacron FANUC RoboShot 55 Si—B molding machine using the following drying and molding conditions:

| | | |
|---|---|---|
| Drying Temperature | ° C. | 110 |
| Drying Time | Hours | 2 |
| Nozzle Temperature | ° C. | 245 |
| Front - Zone 3 Temperature | ° C. | 250 |
| Middle - Zone 2 Temperature | ° C. | 240 |
| Rear - Zone 1 Temperature | ° C. | 230 |
| Mold Temperature | ° C. | 65 |

Cured parts were obtained by heating molded parts to 200° C. for approximately 7 hours. The cured parts were subsequently conditioned at standard lab atmosphere for at least 48 hours. As-molded parts were kept in a standard lab atmosphere. ISO tensile properties were measured according to ISO 527. ISO notched Izod impact was measured according to ISO 178.

These compositions included an aluminum phosphinate catalyst (Exolit® OP1240). Control composition C3 did not include an impact modifier, while comparative compositions C4 and C5 included non-functionalized impact modifiers (Paraloid™ EXL3330, a butyl-acrylate-based copolymer (C4), and SABIC HRG360, an acrylonitrile-butadiene-styrene-based copolymer (C5)). Inventive compositions E4 and E5 included the Lotader® AX8900 glycidyl methacrylate (GMA) poly(ethylene-acrylate) copolymer described herein, compositions E6 and E7 included Lotader® AX8840, an ethylene-glycidyl methacrylate copolymer, composition E8 included Exxelor™ VA-1801, an ethylene copolymer functionalized with maleic anhydride, and composition E9 included Kraton™ FG1901, a styrene-ethylene-butadiene copolymer functionalized with maleic anhydride. All compositions included a mold release agent (low-density polyethylene, LDPE), an antioxidant (Irganox® 1010, “Antioxidant 1010” in the table), a heat stabilizer (Irgafos® 168, “Antioxidant 168” in the table), and Hexion EPON® 1001F epoxy resin. The PBT in each composition was a blend of Valox® 315 PBT pellets and Valox® 315 fine grind PBT.

As demonstrated in Table 4, inventive compositions E4-E9 all included a functionalized impact modifier and generally exhibited improved notched Izod and tensile elongation properties as compared to the comparative compositions C3-C5.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical aspects have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A polymer composition, comprising:
a pre-dynamic cross-linked polymer composition comprising polyester chains joined by a coupler component; and
one or more networking impact modifier additives.

2. The polymer composition of claim 1, wherein the pre-dynamic cross-linked polymer composition is produced by reacting at least a coupler component comprising at least two reactive groups with a chain component comprising a polyester and with one or more networking impact modifier additives, in the presence of one or more catalysts.

3. The polymer composition of claim 1, wherein the one or more networking impact modifier additives forms dynamic covalent bonds with one or more of carboxylic acid end groups or terminal hydroxyl groups of the polyester chains polymer composition.

4. The polymer composition of claim 1, wherein the composition, when subjected to a curing process, forms a dynamic cross-linked polymer composition that (a) has a plateau modulus of from about 0.01 MPa to about 1000 MPa when measured by dynamic mechanical analysis at a temperature above a melting temperature of the polyester chains of the pre-dynamic cross-linked composition and (b) exhibits a capability of relaxing internal residual stresses at a characteristic timescale of between 0.1 and 100,000 seconds above a glass transition temperature of the polyester chains, as measured by stress relaxation rheology measurement.

5. The polymer composition of claim 4, wherein the curing process comprises heating the pre-dynamic cross-linked composition to a temperature of from about 170° C. to about 250° C. for up to about 8 hours.

6. The polymer composition of claim 4, wherein the one or more networking impact modifier additives further comprises an epoxy-functionalized (co)polymer.

7. The polymer composition of claim 6, wherein the epoxy-functionalized (co)polymer comprises a glycidyl methacrylate poly(ethylene-acrylate) copolymer.

8. The polymer composition of claim 4, wherein the one or more networking impact modifier additives further comprises a maleic anhydride copolymer.

9. The polymer composition of claim 8, wherein the maleic anhydride copolymer is a maleic anhydride poly(ethylene-acrylate) copolymer.

10. The polymer composition of claim 1, wherein the one or more networking impact modifier additives is present in an amount between 2 wt. % and 20 wt. %.

11. A method of preparing a pre-dynamic cross-linked polymer composition, comprising:
reacting (a) a coupler component and (b) a chain component comprising a polyester having one or more reactive end groups; and
adding one or more networking impact modifier additives comprising one or more groups reactive with the one or more reactive end groups of the chain component, under such conditions that the one or more networking impact modifier additives covalently bond to the one or more reactive end groups of the chain component,
the reacting being performed in the presence of at least one catalyst that promotes formation of the pre-dynamic cross-linked composition, and
the pre-dynamic cross-linked composition when subjected to a curing process (a) exhibits a plateau modulus of from about 0.01 MPa to about 1000 MPa when measured by dynamic mechanical analysis at a temperature above a melting temperature of the polyester of the pre-dynamic cross-linked composition and (b) exhibits a capability of relaxing internal residual stresses at a characteristic timescale of between 0.1 and 100,000 seconds above a glass transition temperature of the polyester, as measured by stress relaxation rheology measurement.

12. The method of claim 11, further comprising a curing process that comprises heating the pre-dynamic cross-linked composition of from about 170° C. to about 250° C. for up to about 8 hours to form a dynamically cross-linked composition.

13. The method of claim 11, wherein the one or more networking impact modifier additives comprises a maleic anhydride poly(ethylene-acrylate) copolymer or a glycidyl methacrylate poly(ethylene-acrylate) copolymer.

14. The method of claim 11, wherein the one or more networking impact modifier additives is present in an amount between 2 wt. % and 20 wt. %.

15. The method of claim 11, wherein the reacting occurs at a temperature in which the chain component is in a melted state.

16. The method of claim 11, wherein the one or more networking impact modifier additives forms dynamic covalent bonds with one carboxylic acid end groups or terminal hydroxyl groups of the chain component.

17. The method of claim 11, wherein the one or more networking impact modifier additives gives rise to a dispersed phase throughout the polymer composition within which the one or more impact modifier additives is dispersed.

18. A method of forming an article that comprises a pre-dynamic cross-linked polymer composition, comprising:
preparing a pre-dynamic cross-linked polymer composition according to the method of claim 11; and
subjecting the pre-dynamic cross-linked polymer composition to one or more of a compression molding process, a profile extrusion process, or a blow molding process so as to form the article.

19. A method of forming an article that comprises a pre-dynamic cross-linked polymer composition, comprising:
subjecting the pre-dynamic cross-linked polymer composition according to claim 11 to one or more of a compression molding process, a profile extrusion process, or a blow molding process so as to form the article.

20. The method of claim 19, further comprising subjecting the pre-dynamic cross-linked polymer composition to a curing process that comprises heating the pre-dynamic cross-linked composition of from about 170° C. to about 250° C. for up to about 8 hours to form a dynamically cross-linked composition.
